(19) United States
(12) Patent Application Publication
(10) Pub. No.: US 2019/0056700 A1
(43) Pub. Date: Feb. 21, 2019

(54) WEARABLE TERMINAL DEVICE AND CONTROL METHOD OF WEARABLE TERMINAL DEVICE

(71) Applicant: SEIKO EPSON CORPORATION, Tokyo (JP)

(72) Inventors: Atsuhiko MATSUNO, Azumino-shi (JP); Yoshihiro TATARA, Shiojiri-shi (JP); Yosuke WAKAMIYA, Matsumoto-shi (JP); Tomohiro OGAWA, Shiojiri-shi (JP); Masanori OJIMA, Kyoto-shi (JP)

(73) Assignee: SEIKO EPSON CORPORATION, Tokyo (JP)

(21) Appl. No.: 15/764,279

(22) PCT Filed: Oct. 18, 2016
(86) PCT No.: PCT/JP2016/080882

§ 371 Date: Mar. 28, 2018

(30) Foreign Application Priority Data
Oct. 22, 2015 (JP) 2015-208019

(51) Int. Cl. G04G 21/08; G06F 3/0362; G09G 5/36; H01H 25/06

(52) U.S. Cl. CPC G04G 21/08; G06F 3/0362; G04G 9/0064; H01H 25/06; G09G 5/36

(57) ABSTRACT

To provide a wearable terminal device capable of easily realizing an intuitive operation, a control method of a wearable terminal device, and the like. A wearable terminal device includes a display that displays an object, a case provided with the display, a crown provided so as to protrude in a first direction from a side surface of the case, a detector that detects at least one operation of a rotating operation, a pushing operation, and a pulling operation, and a slide movement operation, of the crown, and a processor that executes a command specified based on a detection result by the detector among a plurality of commands.

### CROSS-REFERENCES TO RELATED APPLICATIONS

This application claims priority to Japanese Patent Application No. 2015-000108, filed Jan. 5, 2015, the entirety of which is herein incorporated by reference.

### TECHNICAL FIELD

The present invention relates to a wearable terminal device and a control method of a wearable terminal device.

### BACKGROUND ART

Due to miniaturization of an information device in recent years, a palm-sized (palmtop type) terminal has appeared. Furthermore, a wearable terminal device such as a wristwatch type is widely known. Among these terminals, there is a terminal equipped with a so-called touch panel for performing an operation by touching a display screen.

A display screen (touch panel) of the wearable terminal device is small and it is not easy to operate with a finger or a touch pen. For example, a problem that a touched portion is hidden by the finger or the like or an intended point cannot be touched may be caused.

In contrast, for example, a method of displaying a pointer on a display image and moving the pointer by sliding the terminal itself is disclosed in PTL 1.

### CITATION LIST

### Patent Literature

PTL 1: JP-A-2002-41235

### SUMMARY OF INVENTION

### Technical Problem

In an operation method that causes the GUI (pointer) to follow hardware (terminal), sensitivity of followability of the GUI varies depending on a user and thus, there is a case where it is not possible to operate at an intended speed in an intended direction. Here, the followability of the GUI represents a moving direction and a moving speed of the pointer or the like.

Also, it is difficult to visually recognize a position of the pointer in a small display screen. As such, the conventional operation method of PTL 1 and the like cannot be said to be intuitive and easy.

According to some aspects of the invention, it is possible to provide a wearable terminal device that can easily realize an intuitive operation and a control method of a wearable terminal device.

### Solution to Problem

According to one aspect of the invention, there is provided a wearable terminal device that includes a display that displays an object, a case provided with the display, a protrusion portion provided so as to protrude in a first direction from a side surface portion of the case in plan view from a normal direction of the display, a detector that detects at least one operation of a rotating operation using the first direction as a rotation axis, a pushing operation along the first direction, and a pulling operation along the first direction, and a slide movement operation in a direction intersecting with the first direction, of the protrusion portion, and a processor that executes a command specified based on a detection result by the detector among a plurality of commands.

In the aspect of the invention, a command is executed based on a detection result of which one operation of a plurality of operations by the protrusion portion that include at least the slide movement operation has been performed. With this, it is possible to execute various operations by the protrusion portion and various commands based on the various operations and as a result, it is possible to realize an intuitive and easy-to-understand operation of the wearable terminal device.

In the aspect of the invention, the side surface portion of the case includes an opening that is opened along a second direction intersecting with the first direction, and the protrusion portion is provided to penetrate through the opening, and in a case where an external force in the second direction is applied to the protrusion portion, the slide movement operation may be performed along the second direction.

With this, it is possible to realize the slide movement operation of the protrusion portion by providing an opening having an appropriate structure.

In the aspect of the invention, the detector may detect at least one of a sliding direction and a duration time of the slide movement operation of the protrusion portion, and the processor may specify a command to be executed from among a plurality of commands based on at least one of the detected sliding direction and the detected duration time.

With this, the sliding direction and the duration time of the slide movement operation may be detected and thus, it is possible to realize various slide movement operations and the like.

In the aspect of the invention, the detector may detect a rotation amount and a rotation direction of the rotating operation of the protrusion portion, and the processor may specify a command to be executed from among a plurality of commands based on the detected rotation amount and the detected rotation direction.

With this, the rotation amount and the rotation direction in the rotating operation may be detected and thus, it is possible to realize various rotating operations and the like.

In the aspect of the invention, the detector may detect a duration time of the pushing operation of the protrusion portion, and the processor may specify a command to be executed from among a plurality of commands based on the detected duration time.

With this, the duration time of the pushing operation may be detected and thus, it is possible to realize various pushing operations and the like.

In the aspect of the invention, the protrusion portion may be a crown.

With this, it is possible to use the crown widely used in a wristwatch as the protrusion portion.

In the aspect of the invention, in a case where a first object is displayed, the display may perform guide display for guiding which command is executed by an operation using the protrusion portion in the first object.

With this, a correspondence relationship between an operation on the protrusion portion and the command executed by the operation is displayed on the object and thus, it is possible to realize an easy-to-understand interface.

In the aspect of the invention, the display may display first to N-th guide objects corresponding to first to N-th operations (N is an integer of 2 or more) using the protrusion portion, and in a case where it is detected that an i-th operation (i is an integer satisfying 1≤i≤N) among the first to N-th operations is performed, the processor may execute an i-th command corresponding to the i-th operation.

With this, the guide object corresponding to each operation of the protrusion portion is displayed so as to make it possible to realize an interface that is easy for the user to understand, and the like.

In the aspect of the invention, the first to N-th guide objects may be objects that display the first to N-th commands corresponding to the first to N-th operations to be identifiable.

With this, the guide object corresponding to each operation of the protrusion portion is displayed so as to make it possible to guide the command executed by the operation in a display image.

In the aspect of the invention, the processor may execute a mode selection command for selecting any one of a plurality of modes of the wearable terminal device based on the detection result of the detector.

With this, it is possible to use the protrusion portion on an operation interface for performing mode selection and the like.

In the aspect of the invention, the processor may execute at least one command of a rotation command, a movement command, and a sizing command of an object displayed on the display based on the detection result of the detector.

With this, it is possible to execute various commands for the display object based on the operation of the protrusion portion.

In the aspect of the invention, the processor may execute a sound volume adjustment command based on the detection result of the detector.

With this, it is possible to perform sound volume adjustment based on the operation of the protrusion portion.

According to another aspect of the invention, there is provided a wearable terminal device that includes a display that displays an object, a case provided with the display, a protrusion portion provided so as to protrude in a first direction from a side surface portion of the case in plan view from a normal direction of the display, a detector that detects at least a slide movement operation of the protrusion portion in a direction intersecting with the first direction, and a processor that executes a command specified based on the detection result of the detector, among a plurality of commands of the wearable terminal device, and in a case where a first object is displayed, the display performs guide display for guiding which command is executed by an operation using the protrusion portion in the first object.

In the other aspect of the invention, a protrusion portion capable of executing at least the slide movement operation is provided and a command corresponding to the operation of the protrusion portion is guided in the display image. With this, even in a case where the wearable terminal device may execute various commands and the like, it is possible to present the correspondence relationship between the operation of the protrusion portion and the command to the user, realize an intuitive and easy-to-understand operation, and the like.

According to still another aspect of the invention, there is provided a control method of a wearable terminal device that includes a display that displays an object, a case provided with the display, and a protrusion portion provided so as to protrude in a first direction from a side surface portion of the case in plan view from a normal direction of the display, the control method includes detecting at least one operation of a rotating operation using the first direction as a rotation axis, a pushing operation along the first direction, and a pulling operation along the first direction, and a slide movement operation in a direction intersecting with the first direction, of the protrusion portion, and executing a specified command among a plurality of commands of the wearable terminal device based on a detection result.

According to still another aspect of the invention, there is provided a control method of a wearable terminal device that includes a display that displays an object, a case provided with the display, and a protrusion portion provided so as to protrude in a first direction from a side surface portion of the case in plan view from a normal direction of the display, the control method includes detecting at least a slide movement operation of the protrusion portion in a direction intersecting with the first direction, executing a specified command among a plurality of commands of the wearable terminal device based on a detection result, and performing guide display for guiding which command is executed by an operation using the protrusion portion in the first object, in a case where the first object is displayed.

### BRIEF DESCRIPTION OF DRAWINGS

FIG. 1 illustrates a configuration example (hardware configuration example) of a wearable terminal device of the present embodiment.

FIG. 2 is an external perspective view of the wearable terminal device.

FIG. 3 is a plan view of the wearable terminal device.

FIG. 4 is a cross-sectional view of the wearable terminal device.

FIG. 5A to FIG. 5D illustrate examples of operations of a protrusion portion.

FIG. 6A and FIG. 6B illustrate examples of openings provided in a side surface portion.

FIG. 7A and FIG. 7B illustrate examples of openings provided in the side surface portion.

FIG. 8A to FIG. 8C illustrate examples of cross-sectional structures of the protrusion portion and the like.

FIG. 9 illustrates an example of a cross-sectional structure of the protrusion portion and the like.

FIG. 10 illustrates an example of a detection method of a pulling operation.

FIG. 11 illustrates a specific example of a guide object.

FIG. 12 illustrates a change example of a display screen.

FIG. 13 illustrates an example of a display image displaying a guide object relating to a mode selection command.

FIG. 14 illustrates a change example of the display image at the time of execution of a setting command in a mode.

FIG. 15 illustrates another change example of the display image at the time of execution of the setting command in the mode.

FIG. 16A to FIG. 16C illustrate change examples of the display image at the time of execution of the setting command in the mode.

FIG. 17 illustrates a change example of a display object at the time of execution of the setting command in the mode.

FIG. 18 illustrates an example of a data structure of command specifying information.

FIG. 19 illustrates a configuration example of a wearable terminal device having a rotating member.

### DESCRIPTION OF EMBODIMENTS

Hereinafter, the present embodiment will be described. The present embodiment to be described below does not unreasonably limit contents of the present invention described in the claims. All of the configurations described in the embodiment are not necessarily indispensable constitutional requirements of the present invention.

### 1. Method of Present Embodiment

1.1 Background

First, the method of the embodiment will be described. As described above, in recent years, miniaturization of an information device has progressed and a wearable type information device attached to a user's body has become widely known. It is assumed that such a wearable terminal device has various functions. For example, even in a wristwatch-type terminal device, there is a device that has not only general timepiece functions such as time, time watch, and alarm, but also functions of acquiring and displaying biometric information, activity amount information, and environmental information. Here, biological information is information on a user's biological activity such as a pulse rate and a blood oxygen saturation level, the activity amount information is information on a user's activity (behavior) such as the number of steps and calorie expenditure, and the environmental information is information on an environmental condition around the user such as the current position, altitude, and atmospheric pressure.

In a multifunctional wearable terminal device, it is necessary to carefully examine an operation interface in order to appropriately utilize the function. This is because, as the number of modes (functions) is large, there are many choices of which mode is to be selected (which function is to be used), and thus, an interface capable of quickly selecting a desired mode from the options is required.

Setting (processing) in each mode also varies. For example, in a case of a stop watch, settings such as start, stop, reset, and lap acquisition are performed, and in a case of a log data display mode, switch setting between log display of one day and log display such as a shorter period of several hours (or long-term log display), and the like are performed. As such, in order to realize an intuitive and easy-to-understand interface in a situation where many settings can be made in each mode, it is required to enable various operations of the wearable terminal device 100. For example, it is necessary to design such that an operation for performing given setting and an operation for performing another setting do not overlap (become the same operation).

For this, the wearable terminal device in recent years that employs a touch panel as an operation interfaces is known. In the touch panel, a touched position can be detected and thus, an intuitive operation is possible. For example, even in a case where there are various modes, icons corresponding to each mode are displayed in a list and the user may be allowed to perform an operation of touching a desired icon. Setting in each mode can also be realized by various methods such as performing setting differently according to the touch position, assigning various touch operations (single touch, multi-touch, flick, and the like) to each setting.

However, in the wearable terminal device, it is assumed that a size of the touch panel is very small. For example, as can be understood by taking a size of a dial of the wristwatch into consideration, when it is a wristwatch type, the size of the touch panel is approximately several centimeters in length and breadth respectively. For that reason, there is a concern that a screen cannot be seen by a finger or the like trying to touch or a point different from the intention is touched.

In particular, in the wearable terminal device that acquires biological information and activity amount information, it is also assumed to be used in a state where relatively intense activity such as exercise is being performed. For example, it is useful to cause the wearable terminal device to execute settings such as measuring the lap time during running, displaying a pulse rate for confirming exercise intensity, displaying a moving distance, and the user needs to perform the operation for executing settings. In this case, the operation is performed while moving the body and thus, using of the touch panel increases a possibility of erroneous operation.

For that reason, it is desirable to use not a touch panel, but an interface having a mechanical structure. As long as the interface has a mechanical structure, a certain amount of force is required for an operation, whatever form is used, such as pressing of a button, rotation of a rotating member, sliding of a stick shaped member, and the like and when an effective operation is performed (for example, when the button is sufficiently pressed), a physical feedback called a change in feel is done to the user. With this, even during exercise or the like, it is possible to reliably and accurately perform the operation on the wearable terminal device.

In a conventional wristwatch-type device (multifunctional wristwatch), an interface or the like in which for example, a pressing type mode selection button is provided and modes are switched one by one by single pressing of the mode selection button is known. However, in such an operation interface, in a case where the number of modes becomes large, a situation in which the button must be pressed many times in order to select a desired mode occurs, which is undesirable. This is a problem to be solved caused by the fact that the number of physical buttons provided in the wristwatch-type device is small, only one button can be used for mode selection, and in a broad sense, various operations cannot be performed.

In particular, many wearable terminal devices in recent years can directly or indirectly be connected to a network to acquire information. For example, the wearable terminal device itself may have a communication unit that performs communication via a network such as the Internet. Otherwise, the wearable terminal device may be connected to another device (for example, a PC or a smartphone), that performs communication via a network, using a wired cable or short-range wireless communication and may acquire information from the network via the other device. In this case, the function (mode) of the wearable terminal device may be added due to firmware update or the like and the interface using the mode selection button becomes more complicated.

Also, even in a conventional wristwatch, a wristwatch for performing mode selection by rotation of a rotational bezel is disclosed. In such a timepiece, it is possible to quickly and intuitively select a desired mode from a plurality of modes. However, in the conventional method, a relationship between a state of the rotational bezel and the mode is fixed. For example, when characters such as “TIME” and “STOPWATCH” are physically described (engraved or printed) at each rotational position of a rotational bezel and the rotational position described as the “TIME” is selected, the mode is necessarily set to a time display mode. Such a conventional method cannot be said to be an appropriate interface in a case where adding or updating of functions by update or the like is taken into consideration.

As disclosed in PTL 1, a method of combining a mechanical structure (hardware) and a pointer (GUI) has also been proposed, but a sense of how far the pointer moves on the screen after how much hardware is moved is greatly different among individuals and adjustment is complicated. It is difficult to move a pointer displayed on a small screen to a desired position and it cannot be said that it is a highly convenient interface. In particular, during exercise, confirmation of the pointer position and movement to a target position are extremely difficult.

1.2 Overview of Present Embodiment

Based on the matters described above, the present applicant proposes a wearable terminal device including an interface which has a mechanical structure and is able to handle various modes (functions).

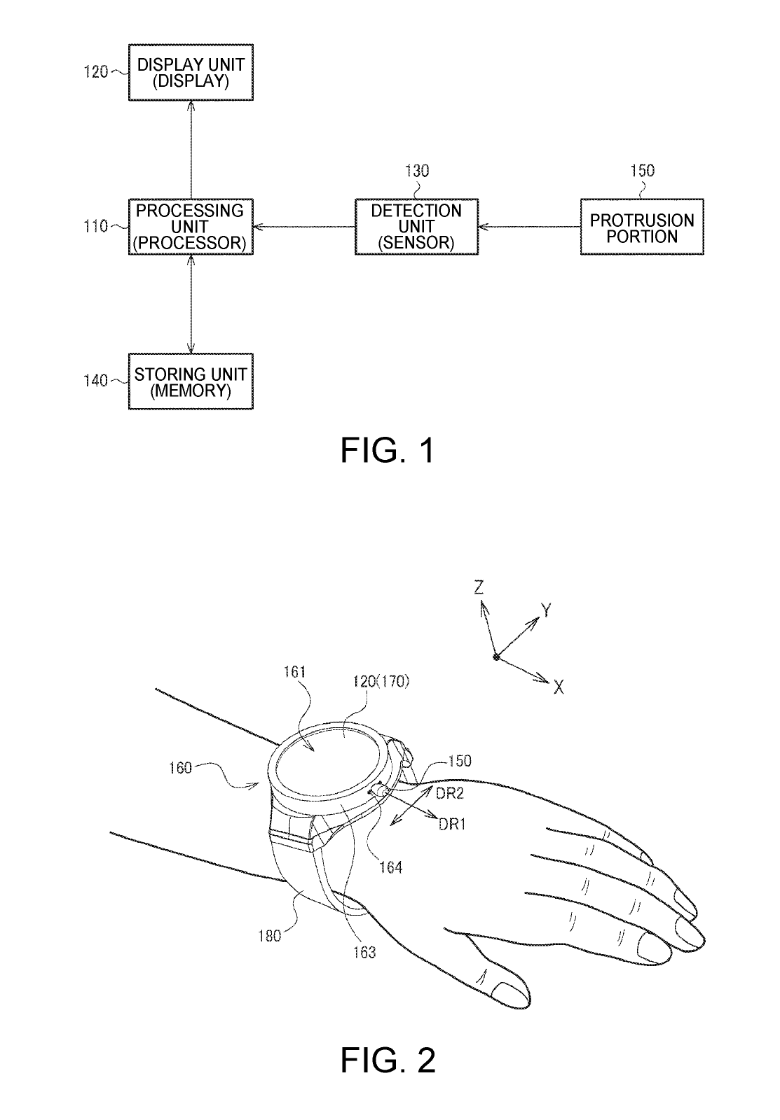

Specifically, as illustrated in FIG. 1, a wearable terminal device 100 includes a display 120 for displaying an object (display object), a case 160 (which will be described later using FIGS. 2 to 4) provided with the display 120, a protrusion portion 150 provided so as to protrude in a first direction DR1 from a side surface portion 163 of the case 160 in plan view from a normal direction of the display, a detector 130 that detects at least one operation of a rotating operation of the protrusion portion 150 using the first direction DR1 as a rotation axis, a pushing operation of the protrusion portion 150 along the first direction DR1, and a pulling operation of the protrusion portion 150 along the first direction DR1, and a slide movement operation of the protrusion portion 150 in a direction intersecting with (orthogonal to in a narrow sense) the first direction DR1, and a processor 110 that executes a command specified based on a detection result by the detector 130 among a plurality of commands of the wearable terminal device 100.

The display 120 (display) is for performing various displays, and can be realized by, for example, a liquid crystal display, an organic EL display, or the like. The case 160 is a member corresponding to a main body of the wearable terminal device 100 and is provided with an operation unit such as the display 120 and the protrusion portion 150. The case 160 may incorporate the processor 110 and may include, for example, a substrate (circuit board) on which the processor 110 is mounted.

Here, an object represents a display object and various forms such as a number, a character, a character string, a figure, an icon, an image (including a background image), and the like are conceivable. For example, an identification object to be described later is also included in the object according to the present embodiment. Otherwise, one image (display image) may be generated by combining a plurality of objects and an object in this case is an element constituting the display image. For example, in a case where a display image is generated by combining a plurality of layers, the object is an element disposed in each layer and each layer includes one object or the plurality of objects. For example, the object may be stored in the storing unit 140 as information in which a display position and display content (display form) in the display 120 are defined. The object is not limited to the one displayed on the entire display area of the display 120 and may be displayed using a portion thereof. In other words, a size (resolution) of the display 120 and a size (resolution) of the object may not match. Hereinafter, an example in which an object is a display image and the display image is displayed using the entirety of the display 120 will be mainly described, but as described herein the object can be variously modified.

The protrusion portion 150 is a member that at least a portion thereof protrudes with respect to the case 160 (display 120 in a narrow sense) and in the present embodiment, the protrusion portion 150 is a member provided by being protruded from a side surface portion 163 of the case 160 toward the first direction DR1. As will be described later with reference to FIGS. 2 to 4 and the like, the case 160 may be configured with an upper surface portion 161 which is a surface on which the display 120 is provided, a lower surface portion 162 which is a surface which comes into contact with a living body at the time of mounting, and a side surface portion 163 connecting the upper surface portion 161 and the lower surface portion 162 to each other. The protrusion portion 150 is provided by protruding from the side surface portion 163 thereof toward the first direction DR1 which is a direction intersecting with the side surface portion 163. The first direction DR1 is a direction that can be observed in plan view from the normal direction of the display 120 and is a direction orthogonal to the normal direction of the display 120 in a narrow sense. In the example of FIG. 2 and the like, the normal direction of the display 120 is the Z-axis direction, and a first direction DR1 is an X-axis positive direction orthogonal to the Z-axis.

The protrusion portion 150 according to the present embodiment can perform at least the slide movement operation and can perform at least one of three kinds of operations including the rotating operation, the pushing operation, and the pulling operation. As for the three operations of the rotating operation, the pushing operation, and the pulling operation, any one of the three operations may be executable, two operations may be executable, and all three operations may be executable. Otherwise, the protrusion portion 150 may be capable of operating other than four types of operations described above. Detailed configuration of the protrusion portion 150 will be described later.

The processor 110 performs various processing such as command execution in the wearable terminal device 100. The processor 110 may be a processor realized by various configurations such as a hardware circuit by a central processor (CPU), a graphics processor (GPU), a digital signal processor (DSP), or an application specific integrated circuit (ASIC).

The command specified by the detector 130 may be, for example, a specified small number (one in a narrow sense) of the plurality of commands in a situation in which a plurality of commands of the wearable terminal device 100 are predefined. The command of the wearable terminal device 100 represents a specific processing (or an execution command of the process) executed in the wearable terminal device 100. In the case of the wearable terminal device 100 according to the present embodiment, as a specific example of the command, a mode selection command, an image processing command, a sound volume adjustment command, and the like are conceivable. Processing corresponding to a mode selection command is executed in the wearable terminal device 100 by execution of each command as mode selection (transition) is performed by executing the mode selection command.

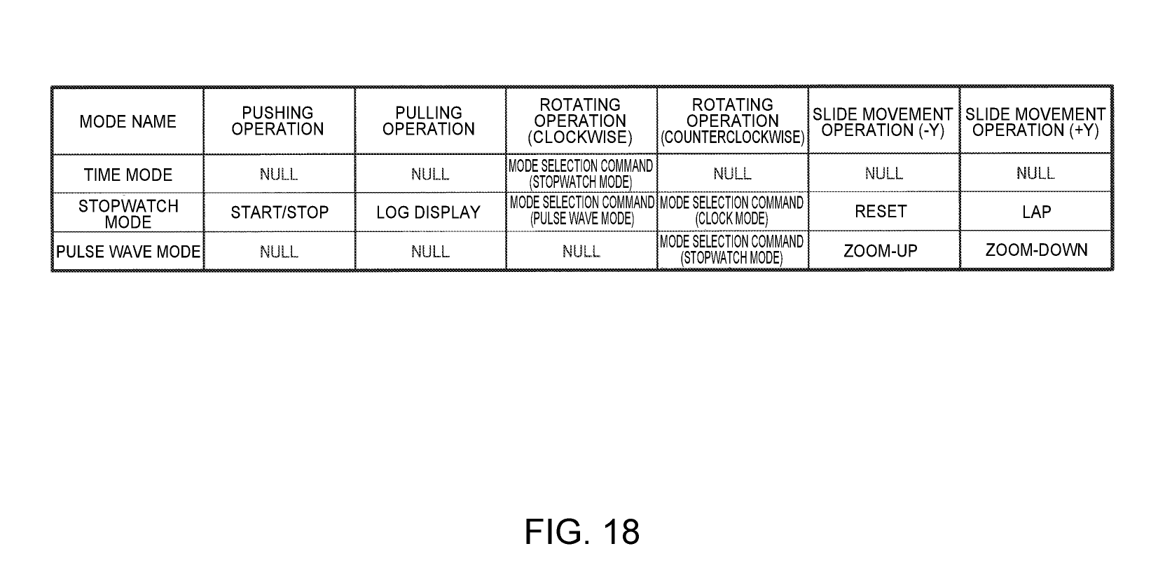

As illustrated in FIG. 1, the wearable terminal device 100 may include a storing unit 140 (memory). The storing unit 140 serves as a work area of the processor 110 and the like and the function thereof can be realized by a memory such as a RAM, a hard disk drive (HDD), and the like. A specific example of the information stored in the storing unit 140 will be described later with reference to FIG. 18. Processing such as command execution in the processor 110 may be one accompanied by reading and writing of information stored in the storing unit 140. Each processing of the present embodiment performed by the processor 110 (processor) is executed based on information (various data or programs) stored in the storing unit 140 (memory).

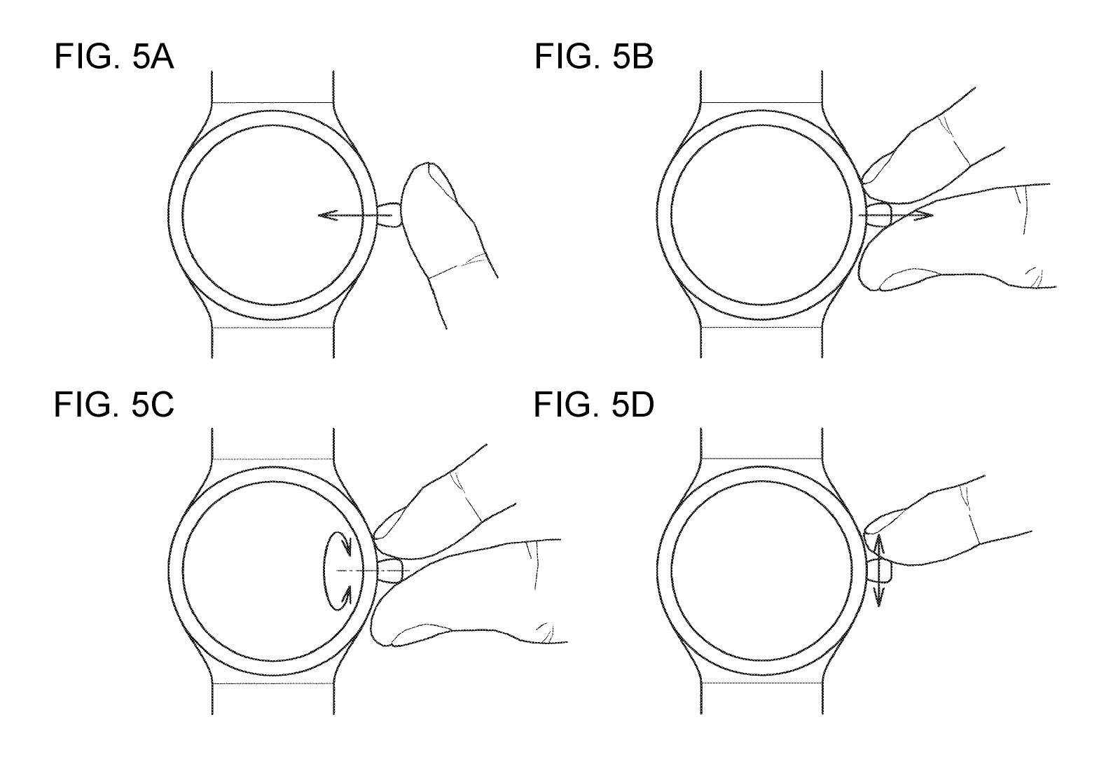

According to the method of the present embodiment, it is possible to realize a wearable terminal device having the protrusion portion 150 capable of at least slide movement operation. Conventionally, although there has been known a wearable terminal device having an operation unit (operation button) which protrudes with respect to the case and is capable of being pushed in and rotated, there is no wearable terminal device performing a slide movement operation. In addition to the rotating operation, the crown provided in the conventional wristwatch can move along a protruding direction of the crown, the movement of the crown can also be interpreted as a pushing operation or a pulling operation. However, the conventional device having the crown is used only for the wristwatch and does not consider application to the multifunctional device, and the crown that performs a slide movement operation is not seen in the past. That is, in the present embodiment, the wearable terminal device 100 capable of executing operations not seen in the conventional method can be realized. In particular, the protrusion portion 150 protrudes with respect to the case 160 and thus, it is easy to operate with a finger or the like and it is also possible to realize an interface in which the possibility of erroneous operation or the like is suppressed. A specific operation example of the rotating operation, the pushing operation, the pulling operation, and the slide movement operation will be described later with reference to FIGS. 5A to 5D together with a structure example of the protruding section 150.

The side surface portion 163 of the case 160 has an opening 164 opened along a second direction DR2 that intersects with the first direction DR1 and the protrusion portion 150 may be provided to penetrate an opening 164. Then, in a case where an external force in the second direction DR2 is applied to the protrusion portion 150, the slide movement operation may be performed along the second direction.

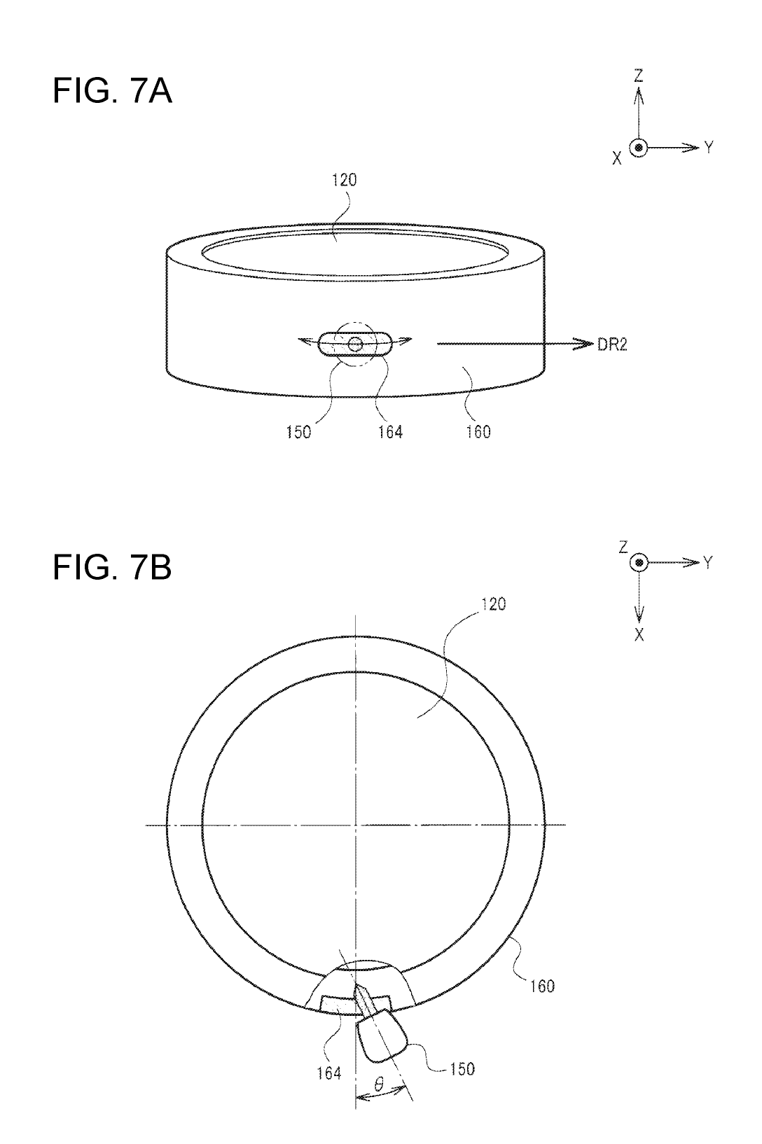

By doing as described above, it is possible to realize the slide movement operation along the second direction DR2 by using the opening 164. The rotating operation using the first direction DR1 as the rotation axis is not accompanied by a translational movement of the protrusion portion 150, and both the pushing operation and the pulling operation in the first direction DR1 are the translational movement performed along the first direction DR1 and are not accompanied by the translational movement in the other directions. For that reason, these operations can be realized by the configuration of the protrusion portion 150 and the case 160 similar to those of the conventional wristwatch. However, the slide movement operation is an operation which is accompanied by the translational movement of the protrusion portion 150 in the direction intersecting with the first direction DR1. In the structure of the conventional wristwatch, the possibility of interference (collision) between the protrusion portion 150 and the case 160 is high. In this respect, in the present embodiment, the opening 164 is provided as will be described later with reference to FIGS. 7A and 7B and thus, it is possible for the protrusion portion 150 and the case 160 to appropriately realize the slide movement operation without being interfered with each other.

The detector 130 may detect at least one of a sliding direction and a duration time of the slide movement operation of the protrusion portion 150 and the processor 110 may specify a command to be executed from the plurality of commands based on at least one of the detected sliding direction and the detected duration time.

Here, the sliding direction represents a direction by a slide movement operation. For example, a protrusion direction (in the example of FIG. 7B, an angle rotated clockwise by θ with respect to the X-axis positive direction) of the protrusion portion 150 after the slide movement operation, with respect to the protrusion direction (in the example of FIG. 2 to be described later, the X-axis positive direction) of the protrusion portion 150 with respect to the case in a state in which the slide movement operation is not performed may be considered. That is, it means an operation in which an end portion of the protrusion portion 150 positioned on a side opposite to the case 160 is moved or displaced in the direction intersecting with the first direction DR1. Specifically, θ illustrated in FIG. 7B may be regarded as the sliding direction. Otherwise, only the sign of θ (only positive and negative) may be regarded as the sliding direction.

With this, the command execution based on the sliding direction becomes possible. For example, when a given command is set to be executed in a case where the protrusion portion 150 is slid by a given angle threshold or more, whether to execute the command or not can be determined by a threshold determination between the sliding direction θ and the angle threshold. Otherwise, as illustrated in FIGS. 7A and 7B, it is also possible to execute different commands for the slide in the clockwise direction and the slide in the counterclockwise direction in the example where it can slide in two directions.

The duration time is information representing the time during which the slide movement operation is being continuously executed, and as an example, the time period during which the state in which the sliding direction θ exceeds a given angle threshold value is continued may be used. Thus, it is possible to execute the operation, which corresponds to a long pushing operation of the button, by the protrusion portion of the present embodiment. That is, it becomes possible to change availability of command execution or to change the command to be executed depending on not only the determination by the sliding direction θ but also depending on whether or not the duration time is greater than or equal to the given time threshold.

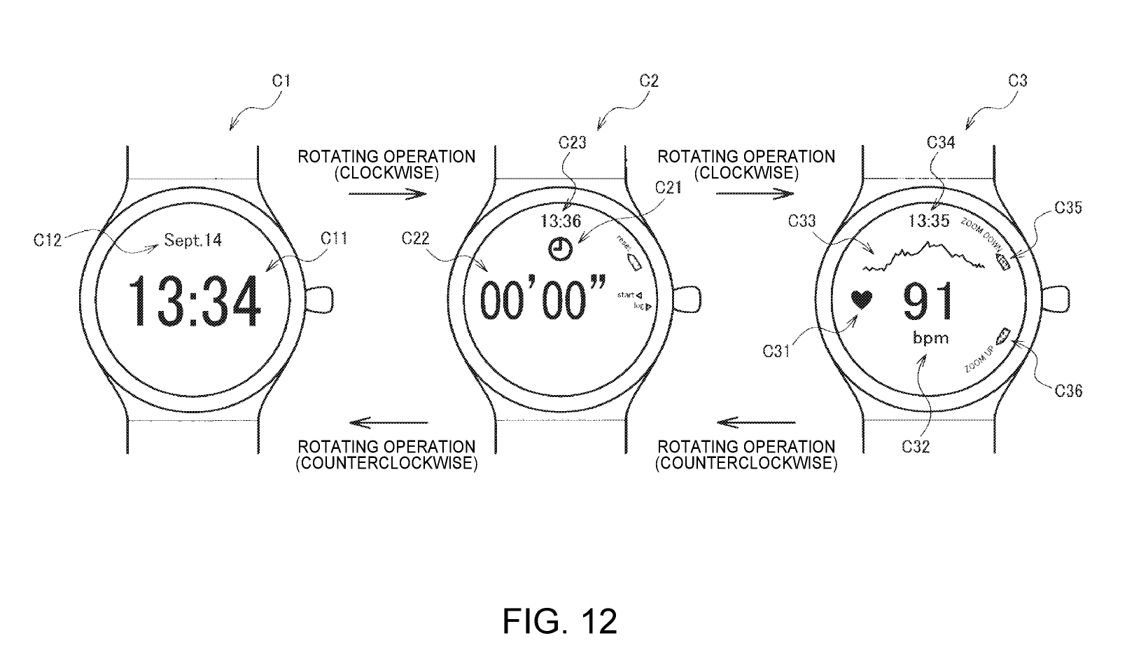

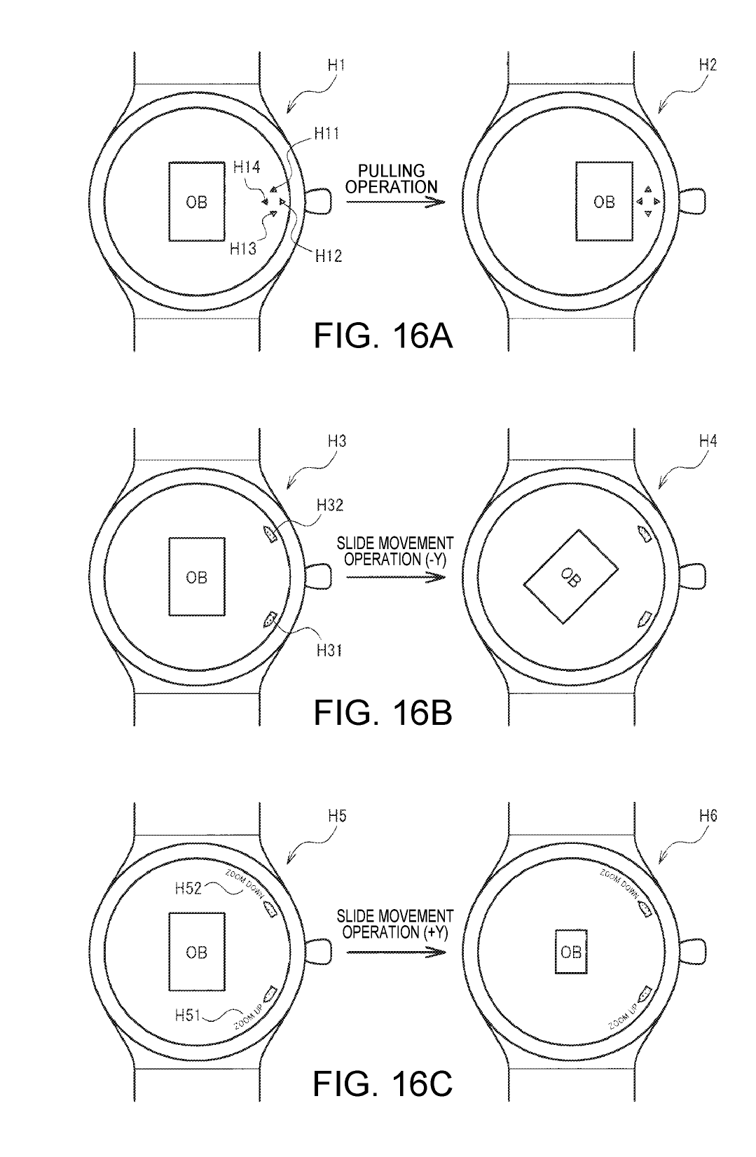

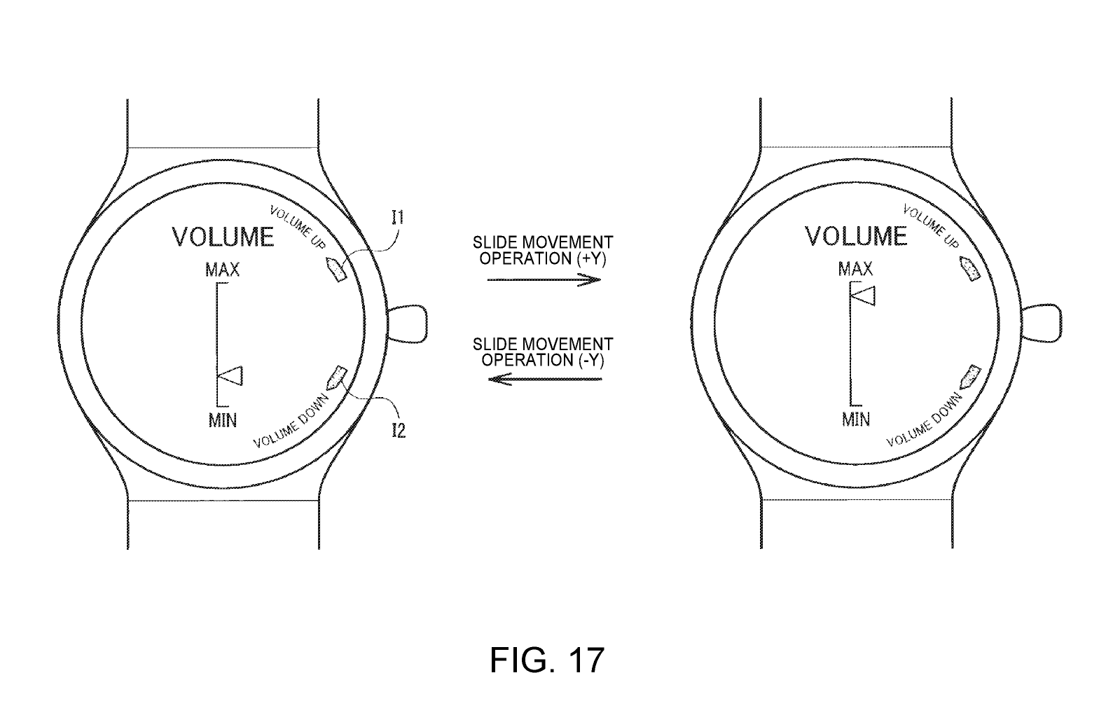

In any case, in the present embodiment, it is not only to realize the slide movement operation of the protrusion portion 150 not seen in the related art but also to realize an interface that enables various inputs by using the direction and duration time of the slide movement operation, and the like. In the following, an example of using the duration time in the case of FIGS. 16B to 17 will be described. However, modification in which the duration time is used can also be made in another embodiment (another mode) such as FIGS. 12 to 15.

The detector 130 may detect a rotation amount and a rotation direction of a rotating operation of the protrusion portion 150, and the processor 110 may specify a command to be executed from a plurality of commands based on the detected rotation amount and rotation direction.

Here, the rotation amount represents a rotation angle (or change amount thereof) of the protrusion portion 150. The rotation direction is information indicating whether direction of rotation with respect to a rotation axis is a right-handed rotation or a left-handed rotation. In a case where the wearable terminal device 100 (protrusion portion 150) is observed from the viewpoint, which is set to the position on the DR1 side than the wearable terminal device 100, the right-handed rotation may be regarded as the counterclockwise rotation and the left-handed rotation may be regarded as the clockwise rotation, or vice versa.

Thus, it is possible to specify a command to be executed by using the direction and the amount of the rotating operation as well. For that reason, for example, it is possible to realize a plurality of kinds of operations as the rotating operations in such a way that a right-handed rotating operation and a left-handed rotating operation are handled as different operations, or handle the rotating operations as different operations depending on whether the rotation amount is larger than a given threshold value or not. As a result, it is possible to realize an interface enabling various inputs. In the following, an example of using the rotation amount in the case of FIG. 16A will be described, but modification in which the rotation amount is used can also be made in other embodiments (other modes) such as FIGS. 12 to 15.

The detector 130 may detect the duration time of the pushing operation of the protrusion portion 150 and the processor 110 may specify the command to be executed from among the plurality of commands based on the detected duration time.

With this, it is possible to detect not only whether the pushing operation is performed or not but also whether the operation is continued or not, specifically whether the pushing operation has been long pressed or not. With this, it is possible to distinguish between pushing in a short time and pushing for a long time (long pushing), and the like and thus, it is possible to realize an interface enabling various inputs. In the following, although an example of using the duration time in the case of FIG. 16A will be described, modification in which the duration time is used can also be made in other embodiments (other modes) such as FIGS. 12 to 15. As described in FIG. 16A, the duration time may also be detected for the pulling operation.

The protrusion portion 150 may be a crown.

The crown is widely known as an interface for operating a wristwatch and thus, the crown shaped protrusion portion 150 is used so as to make it possible to realize an intuitively easy operation interface. When it is the original crown of the wristwatch, winding up of a mainspring, time adjustment, and date adjustment are performed mechanically by rotation according to the position in the protruding direction (in the present embodiment, referred to as DR1) but, in the present embodiment, the crown has the same shape as the crown of the wristwatch and it is not necessary to have a configuration in which winding up of the mainspring or the like is mechanically realized.

In a case where a first object (in a narrow sense, first display image) is being displayed, the display 120 may perform guide display to guide which command is executed by the operation using the protrusion portion 150, in the first object.

With this, it becomes possible to clarify the correspondence relationship between each operation of the protrusion portion 150 and the command executed by the operation on a display image. In the present embodiment, it is possible to perform a plurality of operations using the protrusion portion 150. As described above, it is assumed that there are many commands of the wearable terminal device 100 itself, and when it is left to the user to grasp the correspondence relationship between the operation and the command, the user's burden is large. In that respect, when the guide display is performed on the display image, it is possible to realize an interface that is easy for the user to understand. Furthermore, guide display printing or the like is not performed on the wearable terminal device 100 itself and thus, even in a case where command update processing or the like is performed, it is possible to perform appropriate guide display.

The display 120 may display a first to N-th guide objects corresponding to a first to N-th operations using the protrusion portion 150 and the processor 110 may execute an i-th command corresponding to an i-th operation in a case where it is detected that the i-th operation has been performed among the first to N-th operations.

Here, the guide object is a display object used for guiding the command, and objects having various forms can be used.

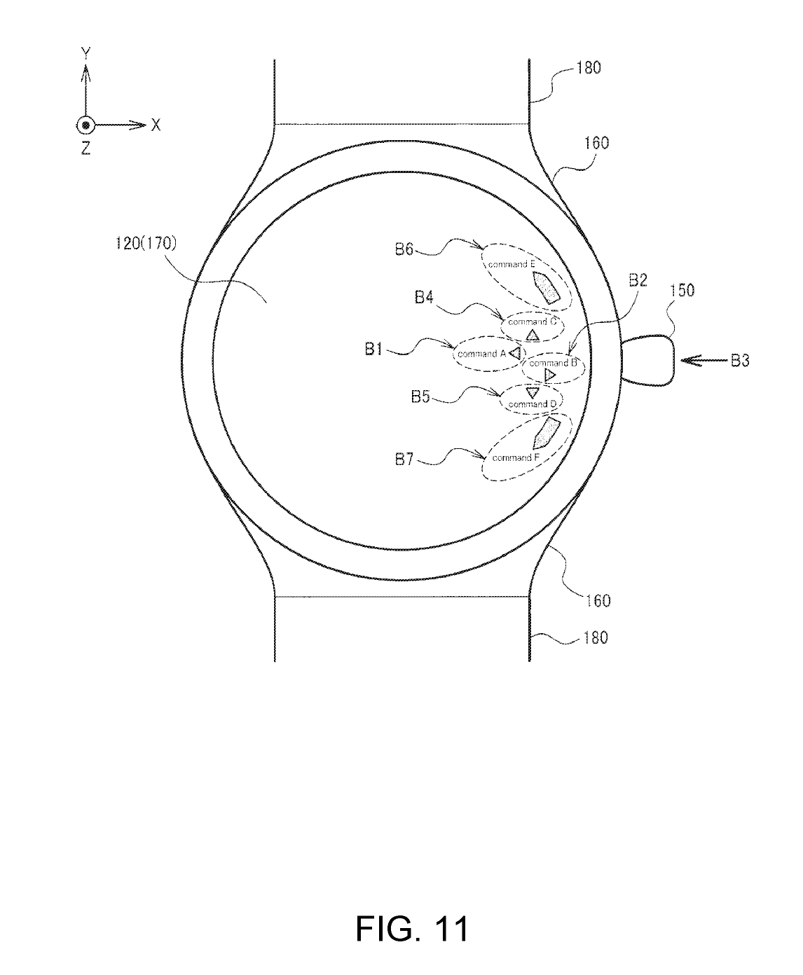

For example, the first to the N-th guide objects may be objects that display the first to the N-th commands corresponding to the first to the N-th operations to be identifiable, and character information may be used as will be described later by using B1 to B2, B4 To B7 or the like of FIG. 11 or icons (figures or the like) for displaying command contents may also be displayed.

Thus, first, it becomes possible to correlate a given command with each operation of the protrusion portion 150. For concrete correlation, information in FIG. 18 and the like may be used, and details will be described later. In the present embodiment, based on such correlation, information on a command correlated with a given operation is displayed on the display image. Here, the guide object may be displayed at a display position corresponding to the operation on the display 120. Here, the “display position corresponding to the operation” represents a position (area) corresponding to each operation in the display image. For example, an area close to the position where the protrusion portion 150 is provided in the peripheral portion of the display image may be used. As illustrated in FIG. 11, the position at which the guide object is displayed corresponding to each operation may be adjusted, and the details will be described later.

The processor 110 may execute a mode selection command for selecting one of a plurality of modes of the wearable terminal device 100 based on the detection result of the detector 130.

Here, the mode of the wearable terminal device 100 corresponds to a state that the wearable terminal device 100 can take. For example, in a case where the wearable terminal device 100 has various states such as time display, alarm, stopwatch, display of altitude, display of atmospheric pressure, and display of a pulse rate, as having been referred to as the time display mode and the alarm mode, the mode is set by being corresponded to each state.

The mode selection command is a command for causing (instructing) the wearable terminal device 100 to select which mode is to be set (which mode to be transitioned to) in the case of having such various modes. An example of a display image in each mode will be described later with reference to FIGS. 12 to 15 and the like, and a specific example of data on the mode will be described later with reference to FIG. 18.

In each mode, a setting command in the mode may be executed based on the operation or the like of the protrusion portion 150. The setting command in the mode is a command for causing the wearable terminal device 100 to execute setting executable in each mode. For example, in the case of a mode in which log data of pulse wave information (pulse rate) is displayed, depending on a usage situation of the user, it is believed that there are cases where it is desired to display a graph of one day or it is desired to display a graph of several hours. Accordingly, in the pulse wave mode, it is desirable to enable zoom up (zoom in) setting and zoom down (zoom out) setting of the graph. Specifically, a zoom-up command and a zoom-down command can be executed as the setting commands in the mode. It is not hindered that there is a mode that does not have a setting command (only display is performed in this example) as in the timepiece mode. Details of a transition example of a display image in a case where the setting command is executed will be described later with reference to FIGS. 12 to 15 and the like, and a specific example of the setting command will be described later with reference to FIG. 18.

By doing as described above, it becomes possible to execute mode selection using the protrusion portion 150. Various relationships between each operation using the protrusion portion 150 and the mode selection command executed by the operation are conceivable and thus, flexible setting is possible. For example, from the viewpoint of simplifying the operation unit other than the protrusion portion 150 as much as possible, some of operations (for example, rotating operation) among a plurality of operations of the protrusion portion 150 may be used for execution of a mode selection command and other operations (such as a pushing operation, a pulling operation, a slide movement operation) may be used for execution of the setting command in each mode. This example will be described later with reference to FIG. 12 and the like.

The processor 110 may execute at least one command of a rotation command, a movement command, and a sizing command of an object displayed on the display 120 based on the detection result of the detector 130.

Although various ways of recognizing the rotation command, the movement command, and the sizing command here are conceivable, it may be considered as one type of setting command in a certain mode for displaying an object (image in a narrow sense), for example. The rotation command is a command to rotate (change the rotation amount with respect to the reference attitude) an image, the movement command is a command to change a display position of the image within the display area, and the sizing command is a command to change a display size of the image. Here, the image may be a log (history graph) such as a pulse rate, and the sizing command in that case corresponds to the zoom up command and the zoom down command described above. Otherwise, image data such as a picture or an illustration stored in the storing unit 140 of the wearable terminal device 100 may be used as the object. Details will be described later with reference to FIGS. 16A to 16C.

Thus, it is possible to realize various processing on the displayed object by an easy-to-understand operation interface.

The processor 110 may execute a sound volume adjustment command based on the detection result of the detector 130.

Here, the sound volume represents a size of sound (alarm sound, voice, music) generated by the wearable terminal device 100. Thus, it is possible to realize processing of adjusting the sound volume by an easy-to-understand operation interface. Details will be described later with reference to FIG. 17.

The method of the present embodiment can be applied to the wearable terminal device which includes the display 120 that displays an object, the case 160 provided with the display 120, the protrusion portion 150 provided so as to protrude in the first direction DR1 from the side surface portion 163 of the case 160 in plan view from a normal direction of the display 120, the detector 130 that detects at least the slide movement operation of the protrusion portion 150 in the direction intersecting with the first direction DR1, and the processor 110 that executes a command specified based on the detection result by the detector 130 among a plurality of commands and in which when the first object is displayed, the display 120 performs guide display for guiding which command is executed by the operation using the protrusion portion 150 in the first object.

As described above, in the wearable terminal device 100 of recent years in which high functionality is remarkable, execution of various commands is indispensable. For that reason, causing a user to remember information on which command among various commands is executed by the operation using the protrusion portion 150 causes a large user burden. For that reason, it is important to perform the guide display to clearly display the correlation between the operation content and the command to be executed in the display image, from the viewpoint of reduction of the user's burden, prevention of erroneous operation, and the like. In this case, the protrusion portion 150 capable of the slide movement operation which cannot be seen with the conventional crown and the like is used so that a flexible operation by the protrusion portion 150 becomes possible and an intuitive and easy-to-understand operation of the wearable terminal device 100 together with the guide display can be realized.

The method of the present embodiment can be applied to the wearable terminal device which includes the display 120 for displaying an object, the case 160 provided with the display 120, the protrusion portion 150 provided so as to protrude in the first direction DR1 from the side surface portion 163 of the case 160 in plan view from a normal direction of the display 120, the detector 130 that detects at least the rotating operation of the protrusion portion 150 using the first direction DR1 as a rotation axis, and the processor 110 that executes a command specified based on the detection result by the detector 130 among a plurality of commands and in which when the first object is displayed, the display 120 performs guide display for guiding which command is executed by the operation using the protrusion portion 150 in the first object.

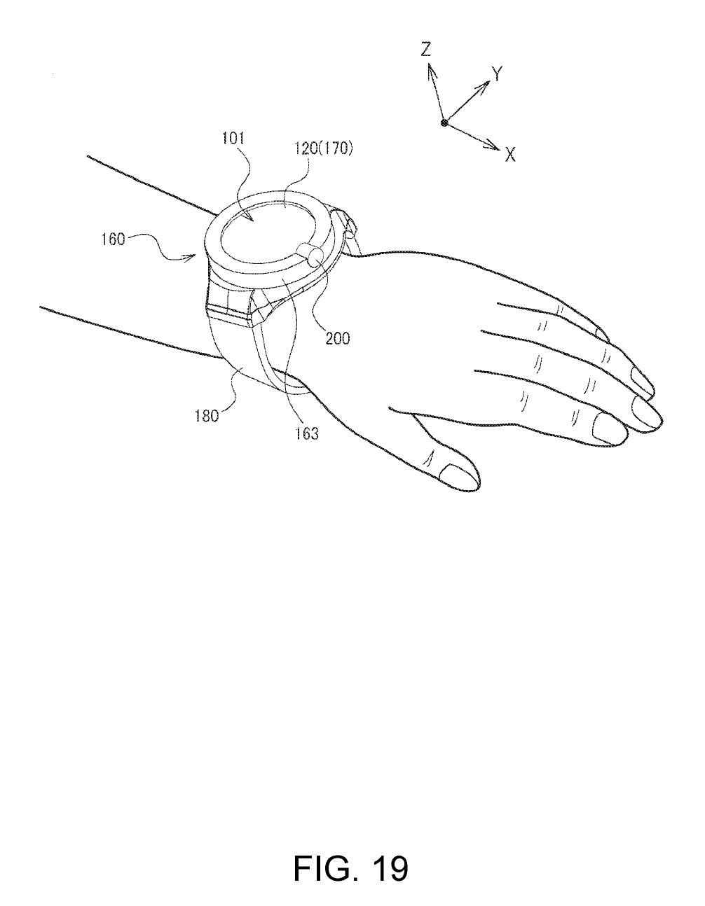

In a case where the slide movement operation is not a prerequisite, an operation interface capable of realizing the rotating operation is not limited to the protrusion portion 150. For example, as illustrated in FIG. 19, it is also possible to use a rotating member 200 which does not protrude with respect to the case 160 as an operation interface. The rotating member of FIG. 19 can be rotated by sliding the surface with a finger. Although it is not an essential configuration, when a force is applied in the X-axis direction by pinching it with two fingers from above and below (from Z-axis positive direction and Z-axis negative direction) or by hooking a nail or the like to a protrusion provided on the surface (position in the X-axis direction can be changed), it is also possible to realize a pushing operation and a pulling operation which will be described later with reference to FIGS. 5A to 5D. That is, it is also possible to think of the protrusion portion 150 of the present embodiment as being replaced with the rotating member 200.

### 2. Structure Example

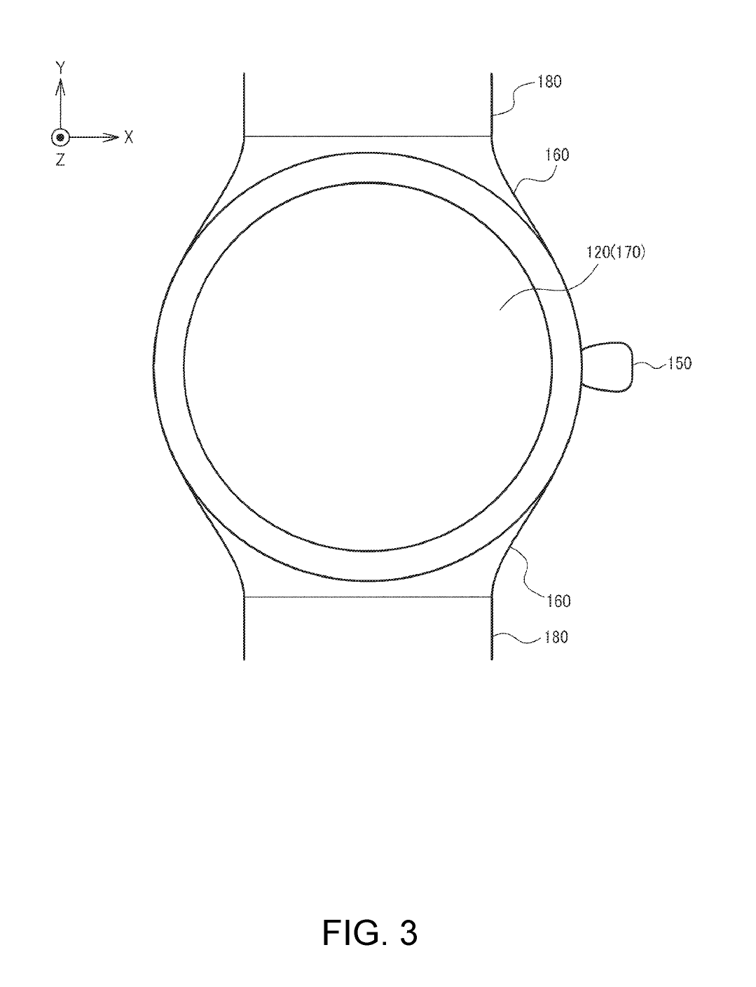

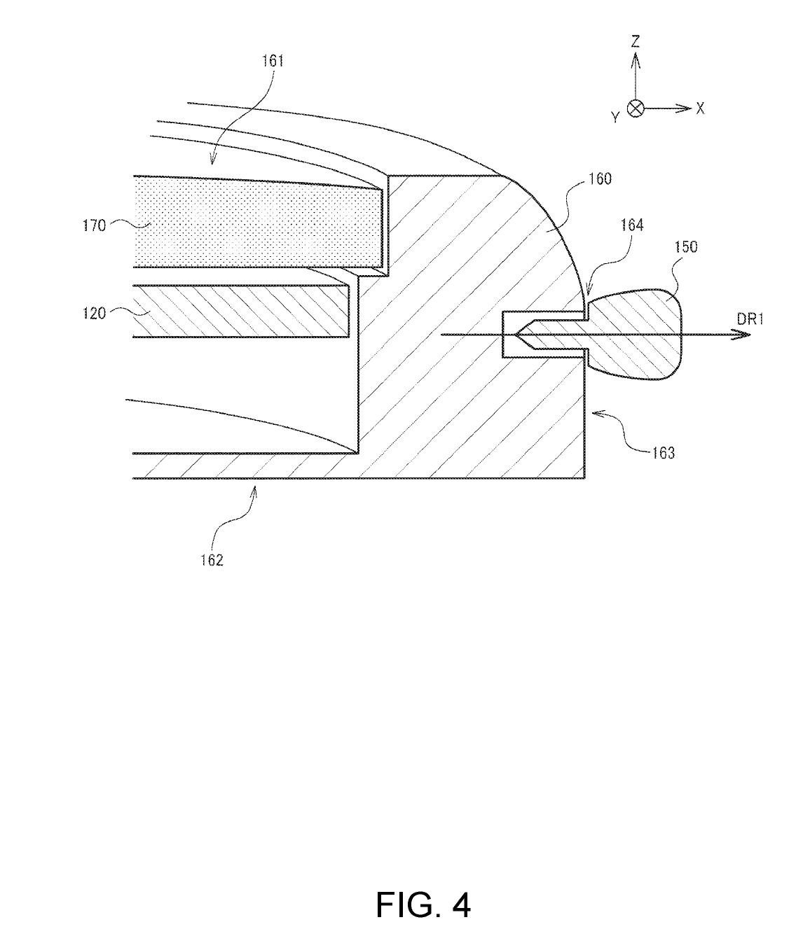

In FIGS. 2 to 4, an example of the structure of the wearable terminal device 100 according to the present embodiment is illustrated. Hereinafter, although description will be made on a wristwatch-type device, the wearable terminal device 100 of the present embodiment is not limited thereto and may be a device attached to another portion of the user. FIG. 2 is a perspective view, FIG. 3 is a plan view, and FIG. 4 is a cross-sectional view, in a state where the wearable terminal device 100 is attached to the user.

The wearable terminal device 100 includes the case 160, the display 120, the protrusion portion 150, a glass 170 serving as a protective member of the display 120, a band portion 180 used for fixing (mounting) the wearable terminal device 100 to the user. In the wearable terminal device 100, FIG. 2 or the like may have a member (not illustrated), for example, an operation unit such as a rotational bezel or a button.

In the following description, for ease of explanation, directions and the like may be expressed using a given coordinate system. Specifically, as illustrated in FIG. 2, a coordinate system is set based on the case 160 of the wearable terminal device 100, and a direction which intersects with the display surface of the display 120 (dial portion) or is a normal direction and which is directed from the back surface toward the front surface in a case where the display surface side of the display 120 is regarded as the front surface is set as the Z-axis positive direction. In a state where the wearable terminal device 100 is attached to a subject, the Z-axis positive direction corresponds to a direction from the subject toward the case 160. Two axes orthogonal to the Z-axis are set as the X-axis and Y-axis, and in particular, the direction in which the band portion 180 is attached to the case 160 is set as the Y-axis. In the example of FIG. 2, at an end point in the Y-axis positive direction and an endpoint in the Y-axis negative direction in the case 160, connection with the band portion 180 is performed. Setting of the coordinate system is also similar in FIG. 2 and subsequent figures. Otherwise, a direction in which the band portion 180 is attached to the case 160 is set as a Y-axis, a direction orthogonal to the Y-axis, a direction along the normal line of a surface where the case 160 contacts the body is set as a Z-axis, and the direction orthogonal to the Y-axis and the Z-axis may be set as the X-axis.

As illustrated in FIGS. 2 to 4, the wearable terminal device 100 has the display 120 (and the glass 170) at a portion corresponding to a dial in a normal timepiece. That is, the upper surface portion 161 which is a surface in the direction along the XY plane is provided on the Z-axis positive direction side (farther side from a living body) of the case 160 in a worn state, and the display 120 is configured to be observable from the upper surface portion side. Here, the glass 170 may be considered as a portion of the case 160 and the surface of the glass 170 on the Z-axis positive direction side may be the upper surface portion 161.

Of the case 160, a surface on the side opposite to the upper surface portion, that is, a surface which is positioned on the Z-axis negative direction side and is close to the living body (in a narrow sense, it comes into contact with the living body) in the worn state is set as the lower surface portion 162. A surface of the case 160 connecting the upper surface portion 161 and the lower surface portion 162 is set as the side surface portion 163. In the example of FIG. 2 and the like, the side surface portion 163 is a curved surface in the direction along the Z-axis direction and the cross sectional shape thereof in the XY plane is substantially circular.

That is, the case 160 according to the present embodiment is a hollow member having the upper surface portion 161, the lower surface portion 162, and the side surface portion 163 as boundaries, and accommodates a circuit substrate in which the processor 110 is installed, the display 120, and the like in the case 160 (Z-axis direction negative direction side than the upper surface portion 161, Z-axis positive direction side than the lower surface portion 162, and inner side of the side surface portion 163 in the XY plane).

However, the detailed structure of the case 160 can be variously modified. For example, the upper surface portion 161 and the lower surface portion 162 may be respectively a curved surface rather than a flat surface, or may have irregularities. Also, the side surface portion 163 may be a surface along the Z-axis direction, a structure having a given angle with respect to the Z-axis direction, a structure having irregularities, or the like can be adopted. Specifically, the side surface portion 163 is provided with the opening 164 for allowing the protrusion portion 150 to protrude from the inside to the outside of the case 160.

A specific example of the protrusion portion 150 will be described. The protrusion portion 150 is a member that protrudes from the side surface portion 163 in the first direction DR1. Here, the first direction DR1 represents the protruding direction of the protrusion portion 150 with respect to the side surface portion 163, so that the first direction DR1 may be any direction as long as it intersects with the side surface portion 163, and various settings are possible. For example, it may be a direction orthogonal to the side surface portion 163, and may be a direction included in the XY plane as long as the side surface portion 163 has a surface along the Z-axis direction. Hereinafter, as illustrated in FIG. 2 and the like, an example in which the first direction DR1 in a normal state (state in which the slide movement operation is not performed) is the X-axis positive direction will be described.

The protrusion portion 150 can perform at least a rotating operation with DR1 as a rotation axis and a pushing operation along DR1. That is, the protrusion portion 150 is not completely fixed to the case 160. Since the pushing operation is possible, the case 160 is designed so that a portion of the protrusion portion 150 can be accommodated inside the case 160. That is, the case 160 has the opening 164 in the side surface portion 163 and the protrusion portion 150 is provided so as to penetrate through the case 160 at the position of the opening 164.

FIG. 5A to FIG. 5D illustrate operation images of the protrusion portion 150. FIG. 5A is an operation image diagram of the pushing operation of the protrusion portion 150, FIG. 5B is an operation image diagram of the pulling operation thereof, FIG. 5C is an operation image diagram of the rotating operation thereof, and FIG. 5D is an operation image diagram of the slide movement operation thereof.

As illustrated in FIG. 5A, the pushing operation can also be said that it is an operation of pushing the protrusion portion 150 in the direction opposite to the first direction DR1 with respect to the case 160 and an operation of reducing a protrusion amount of the protrusion portion 150 with respect to the case 160. As illustrated in FIG. 5B, the pulling operation can also be said that it is an operation of pulling the protrusion portion 150 in the first direction DR1 with respect to the case 160 and an operation of increasing the protrusion amount of the protrusion portion 150 with respect to the case 160. The pushing operation can be executed by, for example, pressing the protrusion portion 150 with the belly of the finger, and the pulling operation can be executed by, for example, gripping the protrusion portion 150 with two fingers and moving the protrusion portion 150 to the DR1.

As illustrated in FIG. 5C, the rotating operation is an operation of rotating the protrusion portion 150 around the first direction DR1 and can be executed by, for example, gripping the protrusion portion 150 with two fingers and performing a twisting operation.

As can be seen from FIGS. 5A to 5C, regarding the pushing operation, the pulling operation, and the rotating operation, the protruding direction of the protrusion portion 150 with respect to the case 160 (for example, direction of the first direction DR1 in the coordinate system described above) is not changed. For that reason, on the premise that the protruding direction is invariable, it is sufficient that the opening 164 has a shape by which the protrusion portion 150 and the side surface portion 163 does not interfere with each other.

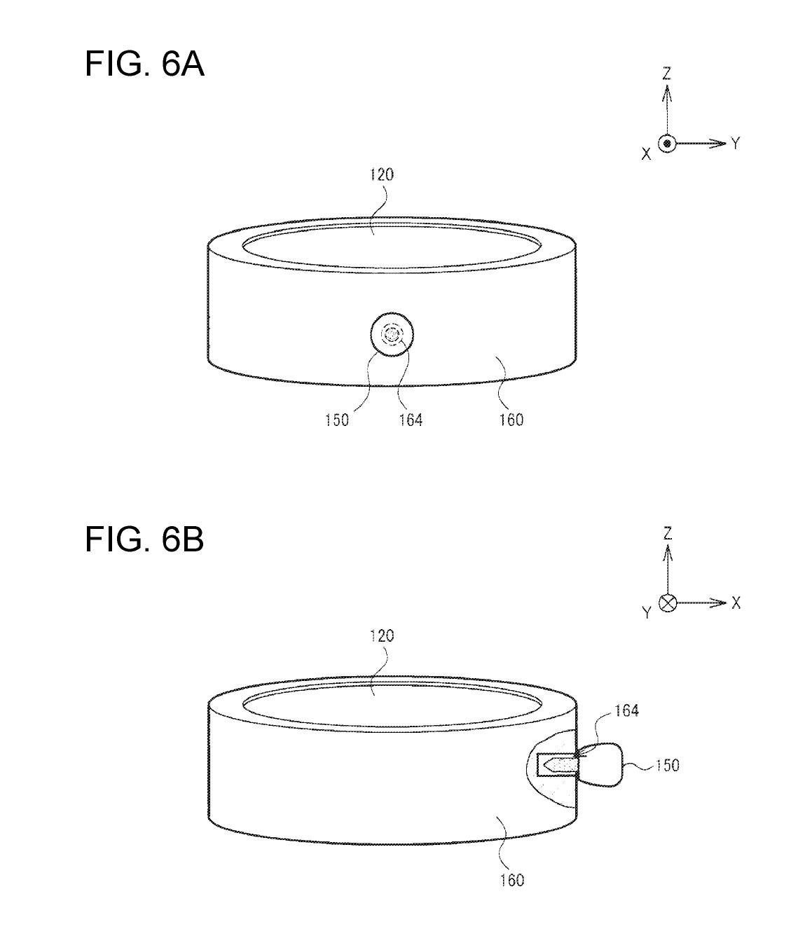

For example, as illustrated in FIGS. 6A and 6B, in the case where the protrusion portion 150 has a columnar portion and penetrates the side surface portion 163 at the columnar portion, the opening 164 having a shape with a given margin in a circular shape which is a cross-sectional shape of the column may be provided.

In contrast, as illustrated in FIG. 5D, the slide movement operation is an operation of moving the protrusion portion 150 in the second direction DR2 intersecting with the first direction DR1. Various second directions DR2 here can be considered. For example, it is assumed that the first direction DR1 in the normal state is the X-axis positive direction, it may be a direction included in the surface in the direction intersecting with the first direction DR1, and in a narrow sense, may be the direction along the YZ plane intersecting with the X-axis positive direction. It is assumed that a thickness (length in the Z-axis direction) of the case 160 is not large when the wearable property of the wearable terminal device 100 is taken into consideration and thus, in the narrow sense, the second direction DR2 may be the Y-axis direction (Y-axis positive direction, or Y-axis negative direction, or both positive and negative directions of the Y-axis). Hereinafter, description will be made on the assumption that the DR2 is in the positive and negative directions of the Y-axis.

In this case, although the slide movement operation may be an operation subjected to a parallel movement while maintaining the protruding direction (DR1) with respect to the case 160, when the movement mechanism is taken into consideration, it is assumed that it is an operation of changing the protruding direction with respect to the case 160, that is, an operation of tilting the protrusion portion 150 with respect to the case 160 is performed as illustrated in FIGS. 7A and 7B. In this case, in a case where the protrusion portion 150 has a columnar portion and penetrates into the side surface portion 163 at the columnar portion, a penetration position in the side surface portion 163 changes before and after the slide movement operation. Accordingly, the opening 164 may be provided in an area including the entire penetration position which is changed by the slide movement operation and specifically, as illustrated in FIGS. 7A and 7B, the opening 164 is preferably provided along the second direction DR2. In the examples of FIGS. 6A to 7B, the size of the opening 164 required for the slide movement operation is larger than that of three operations of the pushing operation, the pulling operation, and the rotating operation and thus, in a case where the slide movement operation is realized, the shape and size of the opening 164 may be determined based on the slide movement operation. However, depending on the specific structure of the protrusion portion 150 and a specific realization method of each operation, the penetration position may be determined depending on different conditions and thus, it is not necessarily limited to matters that the shape and size of the opening 164 are determined with reference to the slide movement operation.

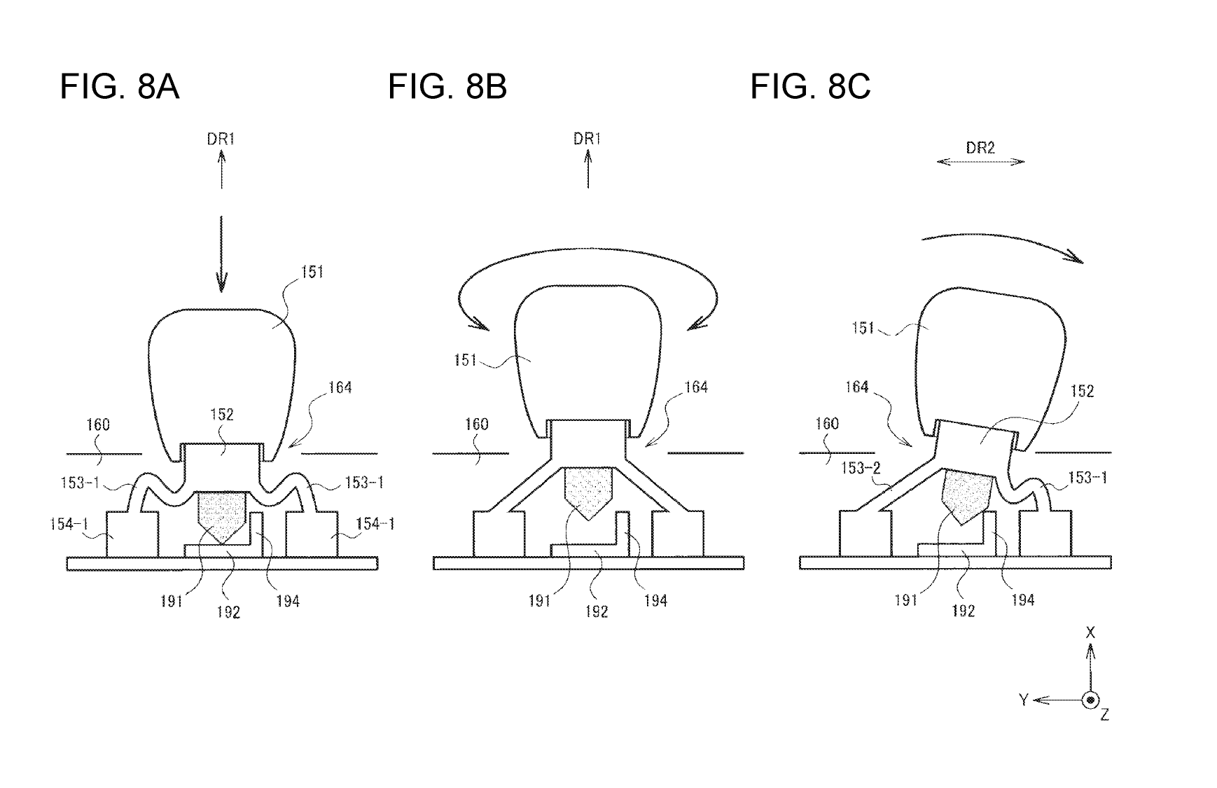

With reference to FIGS. 8A to 8C, a specific configuration example of the protrusion portion 150 for realizing the operations in FIGS. 5A to 5D will be described. The protrusion portion 150 may include an operation member 151 on which an operation by a user is performed, a support member 152 for supporting the operation member 151, an elastic member 153 connected to the support member 152 and configured to extend and contract, and a fixing member 154 connected to the elastic member 153 and used for fixing with a member provided on the case 160 side.

In order to facilitate the user's operation, the size of the operation member 151 may be larger than that of other members such as the support member 152 and may include, for example, a member having a substantially cylindrical shape. Most of the operation member 151 (the whole in a narrow sense) is exposed to the outside of the side surface portion 163 when operability is taken into consideration. The support member 152 is a member that connects a portion of the protrusion portion 150 exposed to the outside of the side surface portion 163 and a portion accommodated inside the case 160 to each other, and is provided at a position at which the side surface portion 163 is penetrated through.

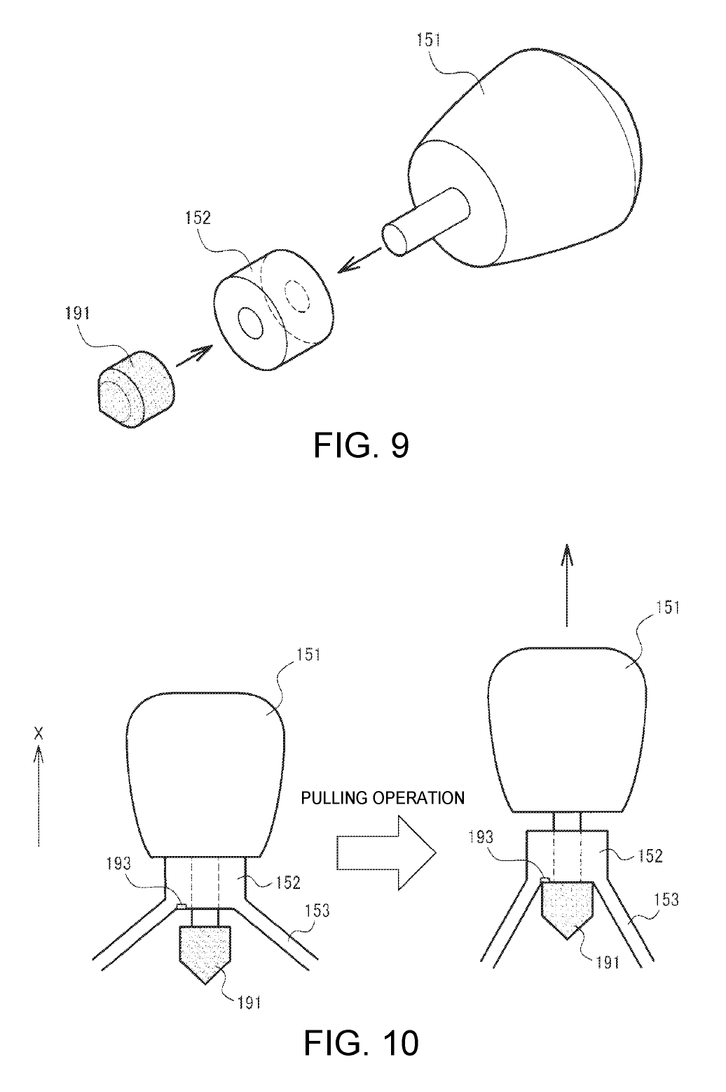

The support member 152 and the operation member 151 may be configured to be relatively rotatable rather than being completely fixed. For example, as illustrated in FIG. 9, the operation member 151 may be configured with a substantially columnar member and a rod-like member, the support member 152 may be formed in a hollow cylindrical shape, and the rod-shaped member of the operation member 151 may be fixed so as to penetrate the inside of the support member 152. In this case, when a diameter of the rod-like member and the size of an inner diameter of the support member 152 are appropriately set, the operation member 151 is configured to be rotatable with respect to the support member 152. Otherwise, a recess may be provided in the rod-like member of the operation member 151 and a projection portion that slidably fits into the recess may be provided on the surface of the support member 152 so that modification in which smooth rotation is obtained can be made. Otherwise, the operation member 151 may be a screw (bolt) and the support member 152 may be a screw hole (nut).

With this, the operation member 151 is rotatable with respect to the support member 152, and since the rotation axis thereof is the DR1 which is the longitudinal direction of the rod-like member, that is, the protrusion direction with respect to the side surface portion 163, it is possible to realize a rotating operation of the protrusion portion 150 with the rotation axis of DR1 as the rotation axis. Various modifications can be made to a specific structure, in which the operation member 151 can be configured to be rotatable, such as providing a projection portion on the operation member 151, providing a recess in the support member 152.

The elastic member 153 extends and contracts in the X-axis direction in a case where a force in the first direction DR1 or a force in the opposite direction to DR1 is applied to the operation member 151. With this, the position of the operation member 151 (and the support member 152) in the X-axis direction can be changed and the pushing operation and pulling operation can be realized. In the case of using the structure illustrated in FIG. 9, it is better to give consideration so that the operation member 151 does not come out of the support member 152 during the pulling operation. For example, the recess and the projection portion may be fitted with each other as described above, or a member larger than the inner diameter of the support member 152 may be connected to the tip of the rod-shaped member like a first contact 191 to be described later.

In a case where a force in the second direction DR2 is applied to the operation member 151, a member (153-1 in FIG. 8C) provided on the DR2 side of the elastic member 153 contracts and a member (153-2 in FIG. 8C) provided on a side in a direction opposite to the DR2 extends. With this, the position of the operation member 151 in the Y-axis direction can be changed and the slide movement operation can be realized. In this case, the position of the support member 152 with respect to the case 160 also changes. Specifically, the support member 152 rotates and moves in the Y-axis negative direction with the Z-axis as the rotation axis.

Next, a method of detecting each operation for the protrusion portion 150 will be described. As illustrated in FIG. 8A, the wearable terminal device 100 may include the first contact 191 provided on the protrusion portion 150 and a second contact 192 provided on the case 160 side.

The first contact 191 is configured to be movable accompanied by the movement of the operation member 151 and the support member 152 along the first direction DR1. For example, as illustrated in FIG. 9, the first contact 191 may be connected to the tip of the rod-shaped member of the operation member 151. In a state where the pushing operation is not performed, the first contact 191 and the second contact 192 do not come into contact with each other, and in a case where a movement is made for a given distance along the first direction DR1, the position and the size of each contact are determined so that the first contact 191 and the second contact 192 come in contact with each other. A circuit that realizes each contact by an electrical contact and detects the contact state of the contact as the detector 130 is used so as to make it possible to detect the pushing operation by the detector 130.

Also, regarding the pulling operation, in a state where the pushing operation is not performed, it suffices if a third contact 193 which does not contact with the first contact 191 and makes contact with the first contact 191 during the pulling operation is provided. A circuit that realizes each contact by an electrical contact and detects the contact state of the contact as the detector 130 is used so as to make it possible to detect the pulling operation by the detector 130. The third contact 193 may be provided at a position at which the position in the Z axis direction is located at the X axis positive direction side than the position of the first contact 191 in the normal state, of the case 160. As long as a relative positional relationship between the operation member 151 and the support member 152 is changed by the pulling operation as illustrated in FIG. 10 modifications in which the third contact 193 is provided at a portion of the support member 152 can be made as illustrate in FIG. 10.

Also, regarding the slide movement operation, in the state where the slide movement operation is not performed, a fourth contact 194 may be provided so as not to make contact with the first contact 191 but to make contact with the first contact 191 during the slide movement operation. A circuit that realizes each contact by an electrical contact and detects the contact state of the contact as the detector 130 is used so as to make it possible to detect the slide movement operation by the detector 130. As an example, the fourth contact 194 disposed at the position illustrated in FIG. 8C may be used. In FIG. 8C, the fourth contact 194 is provided only at the Y-axis negative direction side, but in a case of detecting the slide movement operation in the reverse direction (to the Y-axis positive direction side), the same contact may also be provided at the Y-axis positive direction side.

The rotating operation can be detected by various methods. For example, when the rod-like member and the support member 152 are the screw and the threaded hole, a method of detecting a rotation state of the screw is widely known. For example, a detection switch of the crown rotation amount in a general wristwatch may be used as the detector 130. In the configuration illustrated in FIG. 9, it is considered that the first contact 191 rotates accompanied by rotation of the operation member 151. Accordingly, for example, an optical pattern may be provided on a given surface of the first contact 191 and an optical sensor that emits light to the optical pattern and detects reflected light from the optical pattern may be used as the detector 130. Although, it depends on the method of forming the optical pattern, it is possible to detect the rotation amount and the rotation direction based on, for example, the number of pulses of the sensor output.

### 3. Display Image Example

Next, an example of a display image displayed on the display 120 and an example of a relationship between each display image and the operation for the protrusion portion 150 will be described.

3.1 Example of Mode and Examples of Display Image and Guide Object

As described above, it is assumed that the wearable terminal device in recent years is multifunctional and thus, the number of executable commands increases. In the present embodiment, in order to realize an intuitive and easy-to-understand interface even in such a situation, it is possible to perform a plurality of operations using the protrusion portion 150 and enable various input operations.

However, due to the matters that various input operations are possible, it is difficult for the user to grasp the correspondence relationship as to what kind of commands can be executed by the wearable terminal device 100 by performing which operation. Even if a separate manual is prepared, an act of browsing the manual of a paper medium or browsing an electronic manual with a given device (PC, smartphone, wearable terminal device 100) is cumbersome and the user's burden is large.

For that reason, it is useful to display the correspondence relationship between the operation for the protrusion portion 150 and the command to be executed (or being executed) in the wearable terminal device 100 on the display image.

For example, in a state in which a given display image (first display image) is being displayed on the display 120, when any operation is performed for the protrusion portion 150, a guide display for guiding which command is executed may be performed on the display image.

An example of a specific display image is illustrated in FIG. 11. In FIG. 11, the protrusion portion 150 capable of performing any of the pushing operation, pulling operation, rotating operation, and slide movement operation described above is assumed. The slide movement operation in FIG. 11 is assumed to have a configuration in which the slide movement operation in both directions (slide movement operation that moves in the Y-axis positive direction and the Y-axis negative direction relative to the reference position) is possible, but only one of the directions may be allowed.

In a display image for guiding a command corresponding to the operation of the protrusion portion 150, for example, a guide object (identification object) may be displayed at a position corresponding to each operation in the display image. For example, in a case where the display 120 has a circular display area and the display image is also a circular shape, the guide object may be disposed at a portion (area including B1, B2, and B4 to B7 in FIG. 11) on the side where the protrusion portion 150 is provided in the circular area.

In particular, in the example of FIG. 11, the operation contents are correlated to a display form of the guide object so as to realize a display which is easy for the user to understand. Specifically, in view of the fact that the protrusion portion 150 moves in the X-axis direction in the pushing operation and the pulling operation, an arrow indicating a direction along the X-axis is used as a guide object corresponding to each operation. In view of the fact that the protrusion portion 150 moves toward the X-axis negative direction side by the pushing operation and the protrusion portion moves toward the X-axis positive direction side by the pulling operation, a guide object B1 corresponding to the pushing operation is indicated as an arrow on the X-axis positive direction side (A triangle whose apex is facing in the X-axis negative direction) and a guide object B2 corresponding to the pulling operation is indicated as an arrow on the X-axis positive direction side. Furthermore, a character string representing the contents of the command is disposed at a position corresponding to the arrow. In FIG. 11, a “command A” and a “command B” are indicated and specifically, as will be described later, a character string representing a specific command name such as a “start, or a “stop” may be used.

Also, when the rotating operation is taken into consideration, the movement direction of the surface (surface on the Z-axis positive direction side) observable in FIG. 11 of the protrusion portion becomes the Y-axis positive direction or the Y-axis negative direction. In a case of observing the protrusion portion 150 from a viewpoint B3 which is set on the X-axis positive direction side, the surface moves to the Y-axis positive direction side in a clockwise rotating operation and the surface moves to the Y-axis negative direction side in a counterclockwise rotating operation. In view of the matters as described above, an arrow indicating the direction along the Y-axis is used as the guide object corresponding to the rotating operation. A guide object B4 corresponding to the clockwise rotating operation is set as the arrow on the Y-axis positive direction side and a guide object B5 corresponding to the counterclockwise rotating operation is set as the arrow on the Y-axis negative direction side. Similar to the pushing operation and the like, a character string (“command C” and “command D” in FIG. 11) representing a command name is disposed.

In view of the fact that the protrusion portion 150 moves in the Y-axis direction in the slide movement operation, as guide objects B6 and B7 corresponding to the slide movement operation, curve shaped arrows extending from the reference position toward the Y-axis positive direction side are used. In the example of FIG. 11, a guide object which is a curve shaped arrow extending in a direction in which slide movement is possible is displayed along the outer periphery of the display 120. A guide object corresponding to the slide movement operation in an opposite direction may be a curve shaped object extending from the reference position to the Y-axis negative direction side. Similar to the pushing operation and the like, a character string (“command E” and “command F” in FIG. 11) representing the command name is disposed.

In FIG. 11, in order to clearly distinguish the guide object corresponding to the slide movement operation from the guide object corresponding to the rotating operation described above, the guide object corresponding to the slide movement operation uses a long arrow (having an arrowhead and a shaft) while the guide object corresponding to the rotating operation is a short arrow (triangle or having only an arrowhead). This is due to the difference that the protrusion portion 150 is not moved in the Y-axis direction in the rotating operation, but the protrusion portion 150 moves in the Y-axis direction in the slide movement operation, and such a display is made so as to make it possible to easily distinguish the guide objects of the rotating operation and the slide movement operation.

By doing as described above, it is possible to guide the relationship between an operation and a command in each display image, but it is considered that an executable command depends on a mode. For example, as described above, when it is a stopwatch mode, the necessary commands (setting commands) are start, stop, and the like, and when it is a mode for displaying log data (for example, a history graph displayed in a pulse wave mode), the necessary commands are zoom-up, zoom-down, and the like. The setting command is used for each mode so as to make it possible to assign the same operation to different commands. For example, even with the same operation on the protrusion portion 150, it is also possible to change the command to be executed by the wearable terminal device 100 in the stopwatch mode and the pulse wave mode. That is, when the matters that the display content of the guide object varies for each mode and the display image is different in each mode are taken into consideration, the display content (number of displays, type, or mode) of the guide object for each display image may be changed.

In FIG. 12, a specific realization example is illustrated. In the example of FIG. 12, a timepiece mode (C1), a stopwatch mode (C2), and a pulse wave mode (C3) are available as modes. Among the operations using the protrusion portion 150, an example, in which the rotating operation is used for mode transition, that is, execution of a mode selection command, is illustrated.

In the example of FIG. 12, a clockwise rotating operation is performed so that the mode transitions in order from the timepiece mode to the stopwatch mode to the pulse wave mode and a counterclockwise rotating operation is performed so that the mode transitions in reverse order of matters described above. In a case where the clockwise rotating operation is performed in the pulse wave mode, the mode may be transitioned to the timepiece mode, and in a case where the counterclockwise rotating operation is performed in the timepiece mode, the pulse wave mode may be transitioned into the pulse wave mode. The transition order of mode is not limited to FIG. 12 and various rearrangements are possible.

The display image in each mode will be described. At the timepiece mode (C1), time information (C11) and date information (C12) are displayed. At a time display mode, it is only necessary to display the time and the setting command in the mode is not required. For that reason, the guide object is not displayed in the display image illustrated in C1.

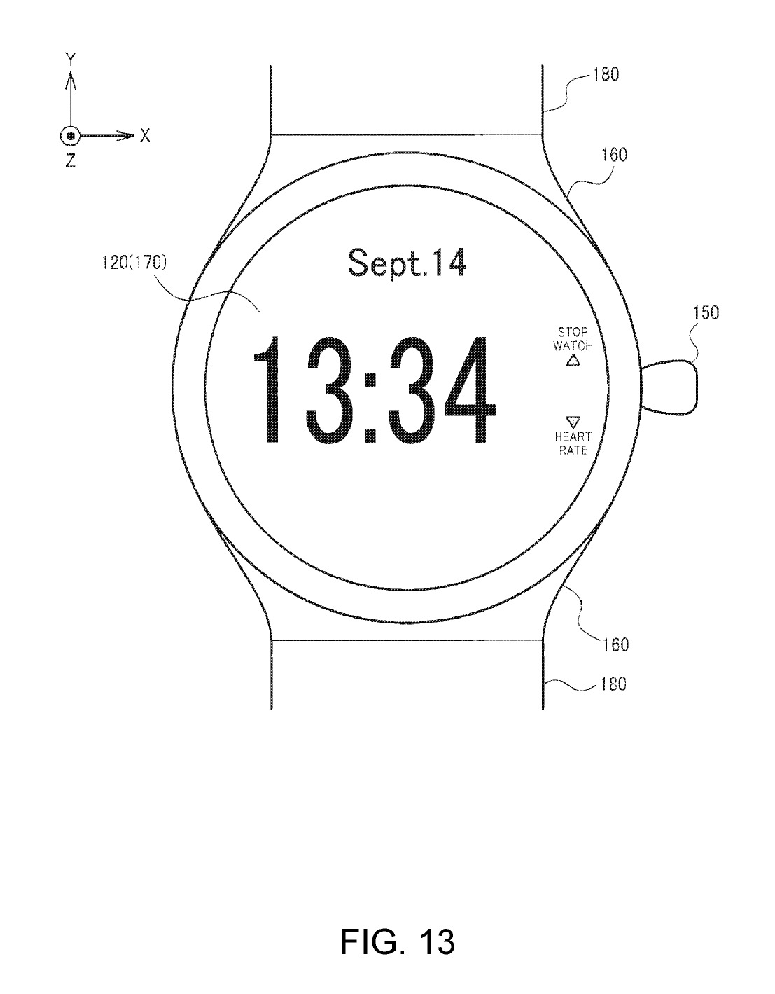

Although omitted in FIG. 12, it is not hindered to display the guide object corresponding to the mode selection command. An example of a display image in the timepiece mode for that case is illustrated in FIG. 13. In FIG. 13, the guide object including an arrow indicating the rotation direction and a character string (character string representing a mode name of a transition destination) representing the mode selection command performed by the rotating operation is displayed.

In the stopwatch mode (C2), a stopwatch type icon (C21) corresponding to the mode, measurement time information (C22), and time information (C23) are displayed. The setting command to be executed in the stopwatch mode is a start command, a stop command, a reset command, a lap command, a log display or the like as described above. However, it is not necessary for each command to be executable at all times in the stopwatch mode. For example, when it is before start of measurement, only the start command and the log display command may be executed and other commands are not executed. Also, when it is during the measurement, the stop command and the lap command can be executed, and when it is after the start of measurement and during the stop, the start command (measurement restart), the reset command, and the log display command can be executed.

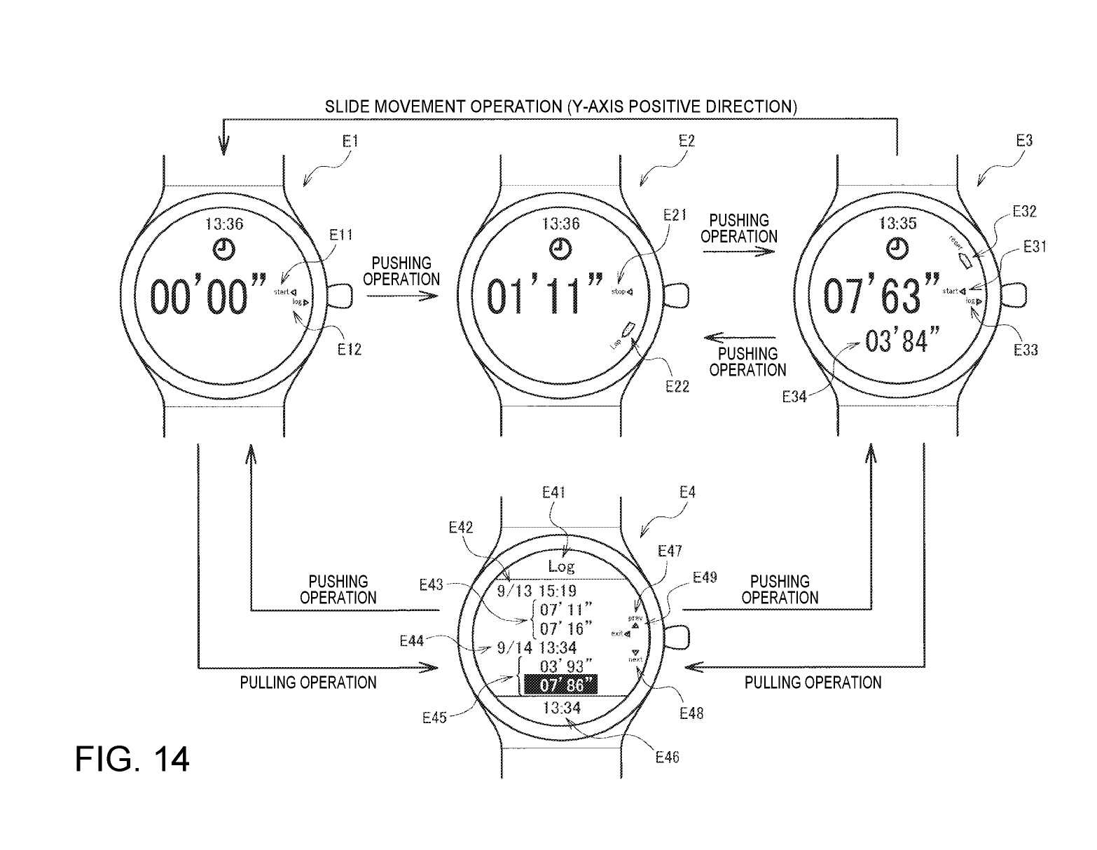

In FIG. 14, an operation (execution of a setting command) of the protrusion portion 150 in the stopwatch mode and a change example of the display image are illustrated. E1 is a display image similar to C2 in FIG. 12 and corresponds to before measurement starts. In E1, it suffices if the start command and the log display command are executable and thus, a start command is assigned to the pushing operation and a log display command is assigned to the pulling operation. In the display image, a guide object E11 which includes a character string “start” indicating the start command and corresponds to the pushing operation and the guide object E12 which includes a character string “log” indicating the log display command and corresponds to the pulling operation are displayed.

In a case where the pushing operation is performed in the state of E1, the state is transitioned into a measurement state. An example of the display image in the measurement state is E2. In the measurement state, it suffices if the stop command and the lap command are executable and thus, the stop command is assigned to the pushing operation and a lap command is assigned to the slide movement operation in the Y-axis negative direction side. In the display image, a guide object E21 which includes a character string “stop” indicating the stop command and corresponds to the pushing operation and a guide object E22 which includes a character string “Lap” indicating the lap command and corresponds to the slide movement operation are displayed. As indicated by E1 and E2, the same operability as a general stopwatch is realized by assigning the start command and the stop command to the same pushing operation, but assignment of the commands is not limited thereto.

Also, in a case where the pushing operation is performed in the measurement state, the state is shifted to the state after the start of measurement and during stop. An example of a displayed image in that case is E3. In E3, it suffices if a start command meaning restart of measurement, a reset command to reset the measurement time, and a log display are executable. In E3, the start command is assigned to the pushing operation, the reset command is assigned to the slide movement operation on the Y-axis positive direction side, and the log display command is assigned to the pulling operation. In the display image, a guide object E31 which includes a character string “start” indicating the start command and corresponds to the pushing operation, a guide object E32 which includes a character string “reset” indicating the reset command and corresponds to the slide movement operation, and a guide object E33 which includes a character string “log” indicating the log display command and corresponds to a pulling operation are displayed. In E3, an example in which the latest lap information (E34) is displayed on the display image on the assumption that the lap command is executed in E2 and lap information is acquired is illustrated. Acquired lap information can also be displayed on a display image such as E2.

In a case where a pulling operation is performed in the state of E1 or E3, the state is shifted to the log display state. An example of a displayed image in that case is E4. In E4, a character string Log (E41) indicating that the log display is performed, time information (E42, E44) at which the measurement is started, acquired lap information (E43, E45), and current time information (E46) are displayed. In the example of E4, the number of pieces of lap information displayed at one time in each measurement is limited to two and thus, in order to cope with acquisition of three or more pieces of lap information, lap information to be displayed can be selected by the rotating operation. In this case, the rotating operation corresponds to the lap information selection command, and the clockwise rotating operation is correlated with a command for selecting lap information one before the lap information (information on the lower side of E45 being highlighted in FIG. 14) in the selected state, and a guide object (E47) including a character string “prev” which represents that fact is displayed. Similarly, the counterclockwise rotating operation is correlated with a command for selecting lap information one after lap information in the selected state and a guide object (E48) including a character string “next” which represents that fact is displayed. A return command that returns from the log display state to another state (for example, previous state) is correlated with the pushing operation and a guide object (E49) including a character string “exit” which represents the return command is displayed.

In the pulse wave mode (C3), a heart-shaped icon (C31), pulse rate information (C32), a graph (C33) illustrating the history of the pulse rate, and time information (C34) are displayed. In a case where log data is displayed as in C33, a period to be displayed may be made variable. Accordingly, a zoom-up command and a zoom-down command may be executed as the setting commands. Accordingly, in C3, each command of zoom-up and zoom-down is assigned to the slide movement operation and a guide object is displayed at a corresponding display position. Specifically, a zoom down command is assigned to the slide movement operation on the Y-axis positive direction side and a guide object (C35) which includes a character string “ZOOM DOWN” for explaining the command is displayed. Similarly, a zoom up command is assigned to the slide movement operation on the Y-axis negative direction side and a guide object (C36) which includes a character string “ZOOM UP” for explaining the command is displayed.

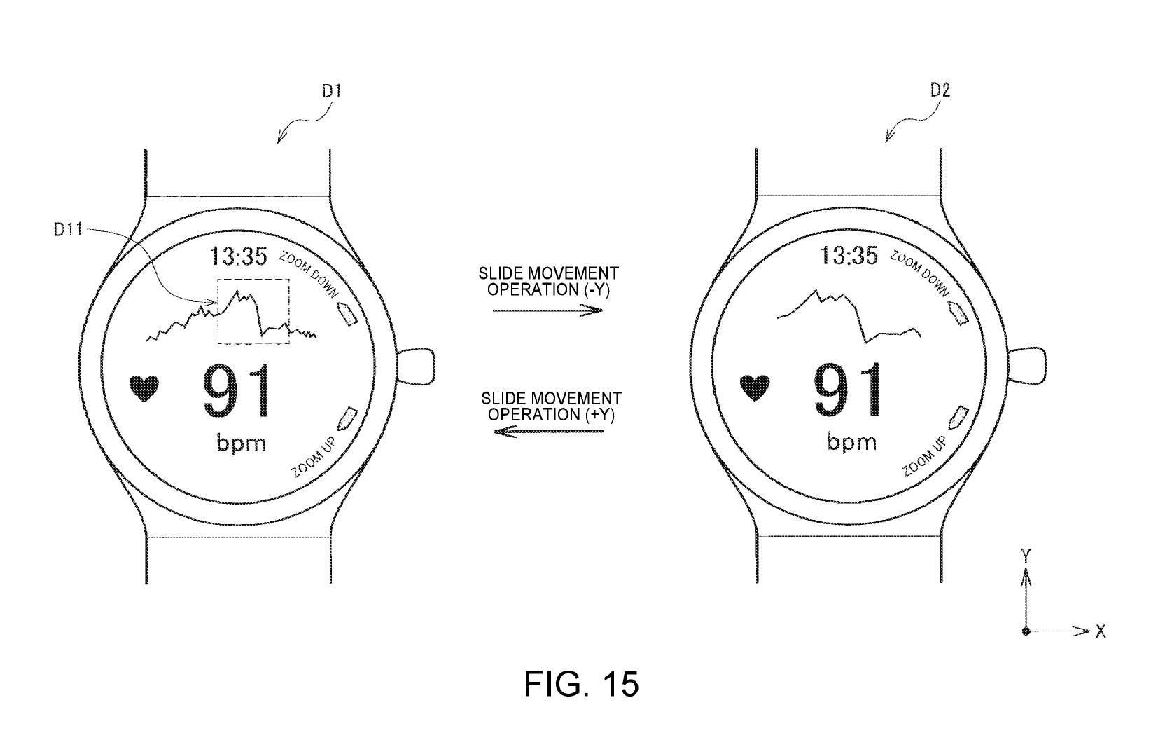

In FIG. 15, a change example of the display image at the time of executing the setting command in the pulse wave mode is illustrated. D1 is a display image similar to C3 in FIG. 12 and D2 represents a display image in a state where a slide movement operation is performed from the state of D1 to the Y-axis negative direction side and a zoom up command is executed. In D2, a portion indicated by D11 of log data of D1 is enlarged and displayed. In a case where the slide movement operation on the Y-axis positive direction side is performed and the zoom down command is executed at D2, D2 returns to the display image of D1. By doing as described above, it is possible to realize an interface capable of properly browsing data in a desired range. Although transition between the two zoom states is illustrated in FIG. 15, three or more levels of display may be performed such as further zooming up from D2 or zooming down further from D1.

3.2 Modification Example of Guide Object

Although an example of a display image, particularly a display example of a guide object has been described with reference to FIGS. 12 to 15, the display image is not limited to the example described above. In particular, in the wearable terminal device 100 according to the present embodiment, there is a possibility that an increase or decrease in the number of modes due to firmware update or the like occurs. Otherwise, a new setting command may be added to the existing mode. For that reason, in a case where the number of modes or setting commands increases, the correspondence relationship between the operation of the protrusion portion 150 and the command executed by the operation and the content of the guide object to be displayed may be changed.

Specifically, in a case where the number of setting commands increases, a setting command is correlated with an operation not previously correlated with a setting command, like the pushing operation or the pulling operation in C3 of FIG. 12, and a guide object corresponding to the added setting command may be displayed in a display area (area where the guide object was also not previously displayed) corresponding to the operation. In this case, the relationship between the operation and the setting command may be reorganized in consideration of the relationship between the added command and the existing command. Specifically, data update processing to be described later with reference to FIG. 18 may be executed.

Although an object including a character string is illustrated as an example of a guide object, different modifications can also be made. For example, when further simplification of display and an increase in visibility of the display image are taken into consideration, only the arrow may be displayed. For example, regarding an operation which is correlated with a certain setting command and in which the operation is performed so as to cause a command to be executed, a corresponding guide object (arrow) is displayed and the guide object corresponding to the operation, which is not correlated with the setting command and for which the command is not executed even when the operation is executed, is not displayed.

In this example, although it is not possible to indicate the contents of the command, it is clearly indicated to the user whether the command is executed or not in a case where each operation is performed. If the protrusion portion 150 is operated but the displayed image has not changed, it is not easy for the user to estimate factors, such as whether the setting command is not assigned and is a normal operation in the first place, whether the setting command is assigned but the wearable terminal device 100 is not operating normally due to failure or the like, or whether the operation was inappropriate (for example, whether the pushing amount was small). When that point is taken into consideration, it can be said that it is a useful interface only by explicitly indicating the operation that the command is not executed.

3.3 Examples of Other Modes

The modes of the wearable terminal device 100 are not limited to those described above with reference to FIGS. 12 to 15, and may have other modes.

For example, the wearable terminal device 100 may execute a movement command, a rotation command, and a sizing command for a given display object (image in a narrow sense). Specifically, the wearable terminal device 100 has an image processing mode and executes three commands described above as setting commands in the image processing mode.

H1 and H2 in FIG. 16A are a change example of a display image in a case where the movement command is executed. The movement command here is a command to translate an image up, down, left, and right, and a movement direction may be correlated with each operation of the protrusion portion 150. At H1, movement commands, that perform upward movement, movement in the right direction, downward movement, and movement in the left direction, are respectively correlated with the clockwise rotating operation, the pulling operation, the counterclockwise rotating operation, and the pushing operation and guide objects H11 to H14 with only the arrows are displayed at the display positions corresponding to the operations. For example, in a case where the pulling operation is performed, as illustrated at H2, an object OB is displayed in a state of being moved to the right direction compared with H1. In the example of FIG. 16A, the arrow representing each operation substantially coincides with the moving direction of the object and thus, the character string representing the moving direction of the object is omitted, but the guide object including the character string may be displayed.

In the present embodiment, as described above, the duration time of the pushing operation or the pulling operation, or the rotation amount of the rotating operation may be detected. In the example of FIG. 16A, the movement amount and the moving speed may be changed based on the detection result of the duration time and the rotation amount. For example, in a case where the duration time is longer than a predetermined value, an object may be continuously moved in the X-axis direction (lateral direction), or a moving speed thereof may be increased as compared with the operation in a short time. In the case of the rotating operation, the rotation amount may be correlated with the movement amount in the Y axis direction (vertical direction).

H3 and H4 in FIG. 16B are a change example of a display image in a case where the rotation command is executed. The rotation command here is a command to rotate the image. At H2, a clockwise rotation command is correlated with the slide movement operation on the Y-axis negative direction side and a counterclockwise rotation command is correlated with the slide movement operation on the Y-axis positive direction side. Then, guide objects H31 and H32 with only the arrow are displayed at the display positions corresponding to the operations. For example, in a case where the slide movement operation on the Y-axis negative direction side is performed, as illustrated at H4, an object OB is displayed in a state of being clockwise-rotated compared with H3. Also, in this case, the character string representing the rotation direction can be omitted. The rotation amount may be a constant value, or a setting command for changing the rotation amount by another operation may be executed. Otherwise, in the present embodiment, as described above, the duration time of the slide movement operation may be detected and thus, for example, in a case where the duration time is longer than the predetermined value, the object may be continuously rotated and otherwise, the rotation speed may be increased as compared with the operation in a short time.

H5 and H6 in FIG. 16C are a change example of a display image in a case where the sizing command is executed. The sizing command here is a command for enlarging and reducing an image. At H5, enlargement (zoom-up and zoom-in) is correlated with the slide movement operation on the Y-axis negative direction side, reduction (zoom-down and zoom-out) is correlated with the slide movement operation on the Y-axis positive direction side, and guide objects H51 and H52 representing enlargement and reduction are displayed at the display positions correlated with operations. For example, in a case where the slide movement operation on the Y-axis positive direction side is performed, the object OB is displayed in a reduced state as compared with H5 as illustrated at H6. It is possible to consider that the sizing command for the image is executed also in display change of the log (history graph) described above with reference to FIG. 15, when the history graph is regarded as an image. Magnification of enlargement and reduction (magnification ratio) may be a constant value, or a setting command for changing the scaling factor by another operation may be executed. In a case where the duration time of the slide movement operation is detected and the duration time is longer than the predetermined value, the object may be sized continuously and otherwise, the magnification ratio may be increased as compared with the operation in a short time.

For example, in a case where it is intended to browse images on the small display 120 of the wearable terminal device 100, it is unable to realize an easy-to-browse interface by simply displaying the entire image on the display 120. In that respect, when enlargement and reduction is made possible, a desired portion of the image can be properly browsed. There is a possibility that only a portion of the image can be browsed in a case where the image is enlarged and thus, there are great advantages of performing the translation movement and rotation movement for browsing a desired region.

In a case where the wearable terminal device 100 has an alarm mode, it is conceivable to notify by sound. In a case where there is an operation on the wearable terminal device 100, there is also the possibility of sounding an operation sound as feedback. Otherwise, in the recent wearable terminal device 100, equipment capable of e-mail reception notification and music playback also increases.

For that reason, it is common to output some kind of sound from the wearable terminal device 100 and there is a demand for adjusting the sound volume thereof. Accordingly, the wearable terminal device 100 may execute a sound volume adjustment command. Specifically, the wearable terminal device 100 may have a tone adjustment mode and may execute the sound volume adjustment command as a setting command in the sound volume adjustment mode.

FIG. 17 illustrates a change example of the display image in a case where the sound volume adjustment command is executed. A sound volume up is correlated with the slide movement operation on the Y-axis positive direction side, and a sound volume down is correlated with the slide movement operation on the Y-axis negative direction, and guide objects I1 and I2 indicating change in the sound volume are displayed at the display positions corresponding to the operations. A change width in the sound volume may be a constant value, or a setting command for changing the change width by another operation may be executed. Similar to FIGS. 16A to 16C, modifications in which the change width according to the duration time of the slide movement operation is changed can also be made.

### 4. Example of Data Structure of Data Stored in Storing Unit

Next, information stored in the storing unit 140 and read and used by the processor 110 will be described. In the processor 110 of the wearable terminal device 100 according to the present embodiment, in a case where each operation of the protrusion portion 150 is performed, it is necessary to execute a command corresponding to the operation. For that purpose, the correspondence relationship between the detection result in the detector 130 and the command to be executed should be clear, and information defining the correspondence relationship may be stored in the storing unit 140.

Accordingly, the storing unit 140 may store command specifying information. The command specifying information is information for specifying the command based on the operation as described above and is information for uniquely specifying a command to be executed in a case where the mode and the operation on the protrusion portion 150 are decided, in a narrow sense.

FIG. 18 illustrates an example of command specifying information. The command specifying information is information obtained by correlating a mode name with a setting command to be executed by being corresponded to an operation. Here, as described above, an example in which the pushing operation, the pulling operation, the rotating operation, and the slide movement operation can be performed in the protruding section 150 is illustrated.

NULL in FIG. 18 indicates that even when a corresponding operation is performed, a command is not executed. The setting command in each mode is the same as the example illustrated in the display image of FIG. 12 to FIG. 15. In the processor 110, a display image may be generated based on the command specifying information illustrated in FIG. 18 and guide object information (information defining a display form or the like of the guide object) which is not illustrated. For example, in a case where the current mode is the pulse wave mode, it is understood that it is necessary to display the guide object at a display position corresponding to the slide movement operation by reading the command specifying information in FIG. 18. Accordingly, information of a guide object (for example, an object including character string “ZOOM DOWN”) corresponding to the slide movement operation in the Y-axis positive direction and a guide object (for example, an object including character string “ZOOM UP”) corresponding to the slide movement operation in the Y-axis negative direction side may be specified from guide object information, may generate a display image in which the specified guide object is displayed at the corresponding display position, and may display the display image on the display 120.

Furthermore, in a case where a given operation is detected in each mode, the processor 110 executes the command specified from FIG. 18. For example, in the case of a time mode, when the clockwise rotating operation is detected, execution of the mode selection command for selecting the stopwatch mode, that is, transition to the stopwatch mode may be performed. However, the relationship between the command and the operation in each mode is not limited to FIG. 18 and various modifications can also be made thereto.

In FIG. 18, an example in which any of a plurality of operations on the protrusion portion 150 is detected by the detector 130 is illustrated. However, the operation to be detected by the detector 130 is not limited thereto. For example, in a case where two or more operations are executed at the same time, the operation may be detected as a different operation from a case where each of the operations is executed independently. For example, the protrusion portion 150 may be configured to be pushed in a sliding state, and the combination operation may be detected. Otherwise, in a case where an operation continues for a predetermined time or more (corresponding to long pushing), the operation may be detected as an operation different from the case where the operation is less than the predetermined time. In addition, the operation using the protrusion portion 150 can be variously modified.

Although the embodiment has been described in detail as above, it will be easily understood by a person skilled in the art that many modifications not deviating practically from the novel matters and effects of the invention are possible. Accordingly, all such modifications are regarded as being included in the scope of the invention. For example, terms described at least once in the specification or drawings together with terms in a broader sense or equivalent different terms can be replaced with the equivalent different term at any point in the specification or drawings. Further, the configuration and operation of the wearable terminal device are not limited to those described in the embodiment, and various modifications can be made thereto.

### REFERENCE SIGNS LIST

DR1: first direction
DR2: second direction
100: wearable terminal device
110: processor
120: display
130: detector
140: storing unit
150: protrusion portion
151: operation member
152: support member
153: elastic member
154: fixing member
160: case
161: upper surface portion
162: lower surface portion
163: side surface portion
164: opening
170: glass
180: band portion
191: first contact
192: second contact
193: third contact
194: fourth contact
200: rotating member

1-15. (canceled)

16. A wearable terminal device comprising:
a display that displays an object;
a case provided with the display;
a crown provided so as to protrude in a first direction from a side surface of the case; and
a detector that detects at least one operation of a rotating operation using the first direction as a rotation axis, a pushing operation along the first direction, and a pulling operation along the first direction, and a slide movement operation in a direction intersecting with the first direction, of the crown.

17. The wearable terminal device according to claim 16,
wherein the side surface of the case includes an opening that is opened along a second direction intersecting with the first direction, and
the crown is provided to penetrate through the opening, and
in a case where an external force in the second direction is applied to the crown, the slide movement operation is performed along the second direction.

18. The wearable terminal device according to claim 17,
wherein the detector detects at least one of a sliding direction and a duration time of the slide movement operation of the crown, and
the wearable terminal device further includes a processor that specifies a command to be executed from among a plurality of commands based on at least one of the detected sliding direction and the detected duration time.

19. The wearable terminal device according to claim 16,
wherein the detector detect a rotation amount and a rotation direction of the rotating operation of the crown, and
the wearable terminal device further includes a processor that specifies a command to be executed from among a plurality of commands based on the detected rotation amount and the detected rotation direction.

20. The wearable terminal device according to claim 16,
wherein the detector detects a duration time of the pushing operation of the crown, and
the wearable terminal device further includes a processor that specifies a command to be executed from among a plurality of commands based on the detected duration time.

21. The wearable terminal device according to claim 16,
wherein in a case where a first object is displayed, the display performs guide display for guiding which command is executed by an operation using the crown on the first object.

22. The wearable terminal device according to claim 21,
wherein the display displays first to N-th guide objects corresponding to first to N-th operations (N is an integer of 2 or more) using the protrusion portion, and
in a case where it is detected that an i-th operation (i is an integer satisfying 1≤i≤N) among the first to N-th operations is performed, the processor executes an i-th command corresponding to the i-th operation.

23. The wearable terminal device according to claim 22,
wherein the first to N-th guide objects are objects that display the first to N-th commands corresponding to the first to N-th operations to be identifiable.

24. The wearable terminal device according to claim 18,
wherein the processor executes a mode selection command for selecting any one of a plurality of modes of the wearable terminal device based on the detection result of the detector.

25. The wearable terminal device according to claim 18,
wherein the processor executes at least one command of a rotation command, a movement command, and a sizing command of an object displayed on the display based on the detection result of the detector.

26. The wearable terminal device according to claim 18,
wherein the processor executes a sound volume adjustment command based on the detection result of the detector.

27. A control method of a wearable terminal device that includes a display that displays an object, a case provided with the display, and a crown provided so as to protrude in a first direction from a side surface of the case, the control method comprising:
detecting at least one operation of a rotating operation using the first direction as a rotation axis, a pushing operation along the first direction, and a pulling operation along the first direction, and a slide movement operation in a second direction intersecting with the first direction, of the crown; and
executing a specified command among a plurality of commands of the wearable terminal device based on a detection result.

28. The control method according to claim 27,
wherein in response to detection result, executing a mode selection command for selecting any one of a plurality of modes of the wearable terminal device.

29. The control method according to claim 27,
wherein in a case where a first object is displayed, displaying a plurality of guidance objects which corresponds to the rotating operation, the pushing operation, the pulling operation, and the slide movement operation.

30. The control method according to claim 27,
wherein in response to detecting the slide movement operation along the second direction, zooming up the object.

31. The control method according to claim 27,
wherein executing a sound volume adjustment command in response to detecting the slide movement operation along the second direction.

32. A control method of a wearable terminal device that includes a display that displays an object, a case provided with the display, and a crown provided so as to protrude in a first direction from a side surface of the case, the control method comprising:
detecting at least a slide movement operation of the crown in a direction intersecting with the first direction;
executing a specified command among a plurality of commands of the wearable terminal device based on a detection result; and
performing guide display for guiding which command is executed by an operation using the crown in the first object, in a case where the first object is displayed.
